(19) United States
(12) Patent Application Publication
(10) Pub. No.: US 2026/0101916 A1
(43) Pub. Date: Apr. 16, 2026

(54) SWEETENED FIBER AND METHODS THEREOF

(71) Applicant: ZeroIN Foods Inc., Halifax (CA)

(72) Inventors: Edgar HERNANDEZ SOSA, Halifax (CA); Veerendhar AINELLY, Halifax (CA); Michael BEH, Halifax (CA); Ebrahim SOLEIMANI, Halifax (CA)

(21) Appl. No.: 19/116,166

(22) PCT Filed: Sep. 27, 2023
(86) PCT No.: PCT/CA2023/051279

§ 371 Date: Mar. 27, 2025

Related U.S. Application Data
(60) Provisional application No. 63/410,621, filed on Sep. 27, 2022.
(60) Provisional application No. 63/529,596, filed on Jul. 28, 2023.

(51) Int. Cl. A23L 27/30; A23F 5/46; A23G 1/40; A23G 1/56

(52) U.S. Cl. CPC A23L 27/36; A23F 5/465; A23G 1/40; A23G 1/56

(57) ABSTRACT

The present disclosure relates to sweetened fibers, compositions thereof, and products comprising the sweetened fiber of the present disclosure, and uses thereof. The present disclosure also relates to methods of preparing the sweetened fibers of the present disclosure.

### RELATED APPLICATIONS

This PCT application claims the benefit of priority of U.S. provisional application Ser. No. 63/410,621, filed Sep. 27, 2022 and U.S. provisional application Ser. No. 63/529,596, filed Jul. 28, 2023, each of which are incorporated by reference in their entirety.

### FIELD

The present disclosure relates to sweetened fibers, uses thereof, and methods of preparing sweetened fibers.

### INTRODUCTION

The sweet taste is an essential factor contributing to the taste profile of many consumer food and beverage products. Traditionally, natural sugar, or sucrose, has been used for centuries to provide the sweetness. However, high sugar consumption has been linked to many metabolic diseases and disorders. Therefore, the food industry has a growing need for sugar alternatives.

Currently, many sugar substitutes exist commercially including artificial and natural sweeteners. Some examples include Aspartame™, Sucralose™, Splenda™ Saccharin™, Astraea™, Isomalt™, Palatinose™, Stevia™ Truvia™, and Monatin™. Although these commercial substitutes are sweet in taste, they present many disadvantages. For instance, many have an undesirable and lingering aftertaste. Some compounds have also been linked to inflammatory conditions and issues with gastrointestinal health.

WO2019193356 describes a high intensity sweetener glycoside that has been modified by a glycosyltransferase, where the high intensity sweetener glycoside such as steviol glycosides are attached for further units of glucose through the enzymatic action of the glycosyltransferase.

US20210002318A describes a method of preparing steviol glycosides using recombinant microorganisms and enzymes to add one or more units of glucose to naturally occurring steviol glycosides.

Accordingly, there is a need for healthier sugar alternatives that provides a sweet taste profile similar to that of natural sugar.

### SUMMARY

It has been shown herein that a sweetened fiber can be prepared by treating a fiber and a sweetener under acidic conditions to covalently attach the sweetener to molecules of the fiber through glycosidic bonds. It was determined that the sweetened fiber comprises trisubstituted saccharide monomers. Analyses described herein show that the sweetened fiber of the present disclosure has a sweet taste that can be tuned to mimic that of sucrose without an undesirable aftertaste. Further, since the sweetener is attached to molecules of fiber, the sweetened fiber can also be used as a fiber supplement and contribute positively to the health of the end user.

In another aspect, the present disclosure includes a sweetened fiber comprising:
a sweetener attached to at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer.

In another aspect, the present disclosure includes a sweetened fiber comprising:
a sweetener attached to at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer, and wherein the trisubstituted saccharide monomer is attached to another saccharide monomer at the C1 position of the trisubstituted saccharide monomer.

In another aspect, the present disclosure includes a sweetened fiber comprising:
at least one molecule of fiber,
a sweetener attached to the at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer.

In another aspect, the present disclosure includes a sweetened fiber comprising:
at least one molecule of fiber,
a sweetener attached to the at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer, and wherein the trisubstituted saccharide monomer is attached to another saccharide monomer at the C1 position of the trisubstituted saccharide monomer.

In another aspect, the present disclosure includes a method of preparing a sweetened fiber,
wherein the sweetened fiber comprises a sweetener attached to at least one molecule of fiber, wherein each of the at least one molecule of fiber is attached to the sweetener through an oxygen atom of the sweetener via a glycosidic bond, and wherein the at least one molecule of fiber comprises a trisubstituted saccharide monomer,
wherein the method comprises:
   combining the fiber and the sweetener to obtain a fiber mixture,
   combining the fiber mixture with an acid to obtain a fiber paste, and heating the fiber paste to obtain a heated fiber paste, the heated fiber paste comprising the sweetened fiber.

In another aspect, the present disclosure includes a method of preparing a sweetened fiber,
wherein the sweetened fiber comprises a fiber and a sweetener attached to at least one molecule of the fiber, wherein each of the at least one molecule of the fiber is attached to the sweetener through an oxygen atom of the sweetener via a glycosidic bond, and wherein the at least one molecule of the fiber comprises a trisubstituted saccharide monomer;
wherein the method comprises:
   combining the fiber and the sweetener to obtain a fiber mixture,
   combining the fiber mixture with an acid to obtain a fiber paste, and heating the fiber paste to obtain a heated fiber paste, the heated fiber paste comprising the sweetened fiber.

In another aspect, the present disclosure includes a sweetened fiber prepared by a method of preparing a sweetened fiber of the present disclosure.

In another aspect, the present disclosure includes a composition comprising a sweetened fiber of the present disclosure.

Accordingly, in one aspect, the present disclosure includes a sweetened fiber composition comprising:
a fiber; and
a sweetener attached to at least one molecule of the fiber,
wherein each of the at least one molecule of the fiber is attached to the sweetener through an oxygen atom of the sweetener via a glycosidic bond, and
wherein the at least one molecule of the fiber comprises a trisubstituted saccharide monomer.

In another aspect, the present disclosure includes a sweetened fiber composition comprising:
a fiber; and
a sweetener attached to at least one molecule of the fiber,
wherein each of the at least one molecule of the fiber is attached to the sweetener through an oxygen atom of the sweetener via a glycosidic bond, and
wherein the at least one molecule of the fiber comprises a trisubstituted saccharide monomer, and wherein the trisubstituted saccharide monomer is attached to another saccharide monomer at the C1 position of the trisubstituted saccharide monomer

In another aspect, the present disclosure includes an edible product comprising the sweetened fiber or composition of the present disclosure.

In another aspect, the present disclosure includes a sweetener product comprising the sweetened fiber or composition of the present disclosure in a packaging.

In another aspect, the present disclosure includes a use of the sweetened fiber of the present disclosure in the preparation of an edible product.

In another aspect, the present disclosure includes a use of the sweetened fiber or composition of the present disclosure for replacing sugar in the preparation of an edible product.

In another aspect, the present disclosure includes the sweetened fiber or composition of the present disclosure for use in the preparation of an edible product.

In another aspect, the present disclosure includes the sweetened fiber or composition of the present disclosure for use in the replacement of sugar.

In another aspect, the present disclosure includes a sweetener composition comprising a mixture of modified saccharide products obtained by a reaction process involving:
(i) thermal hydrolysis of a saccharide having a degree of polymerization (DP) greater than 3 to form one or more depolymerization products; and
(ii) coupling of the one or more depolymerization products, which comprise one or more hydrolyzed polysaccharides, oligosaccharides with DP greater than 2, or monosaccharides, in the presence of one or more organic compounds or a derivative thereof, to form one or more coupling products, wherein the organic compound, or derivative thereof, has a sweetness level equal to or greater than sucrose; and
(iii) repolymerization of the coupling products to form an oligosaccharide coupled organic compound, a polysaccharide coupled organic compound, a hydrolyzed polysaccharide coupled organic compound or a monosaccharide coupled organic compound.

In another aspect, the present disclosure includes a consumable product comprising the sweetener composition of the present disclosure.

In another aspect, the present disclosure includes a food product, beverage product, nutritional supplement product, or a pharmaceutical formula product comprising the sweetener composition of the present disclosure.

In another aspect, the present disclosure includes a use of the sweetener composition of the present disclosure as a sugar substitute.

In another aspect, the present disclosure includes a prebiotic comprising the sweetener composition of the present disclosure.

In another aspect, the present disclosure includes a process for preparation of a sweetener composition having a mixture of modified saccharide products, the process comprising the steps of:
(i) thermal hydrolysis of a saccharide having a degree of polymerization (DP) greater than 3 to form one or more depolymerization products;
(ii) coupling of the one or more depolymerization products, which comprise one or more hydrolyzed polysaccharides, oligosaccharides with DP greater than 2, or monosaccharides, with one or more organic compounds or a derivative thereof, to form one or more coupling products, wherein the organic compound, or derivative thereof, has a sweetness level equal to or greater than sucrose; and
(iii) repolymerization of the coupling products to form an oligosaccharide coupled organic compound, a polysaccharide coupled organic compound, a hydrolyzed polysaccharide coupled organic compound or monosaccharide coupled organic compound.

### DRAWINGS

The embodiments of the disclosure will now be described in greater detail with reference to the attached drawings in which:

FIG. 1 shows an exemplary MALDI-TOF spectrum of an exemplary sweetened fiber of the present disclosure prepared according to Example 1.

FIG. 2 shows the degree of polymerization (DP) distribution of bulk corn fiber (starting material) vs bulk corn sweetened fiber of the present disclosure (Panel A), and of fractionated corn fiber vs fractionated corn sweetened fiber of the present disclosure (Panel B).

FIG. 3 shows a graph showing the solubility (g/100 mL) of sucrose and of an example sweetened fiber of the present disclosure in water.

FIG. 4 shows the binding energy of Rebaudioside M, sweetened fiber model 1 with one trisubstituted saccharide monomer, and sweetened fiber model 2 with three trisubstituted saccharide monomers, onto mGluR3 receptor.

FIG. 5 shows a flowchart of an exemplary method of preparing a sweetened fiber of the present disclosure.

FIG. 6 shows bar graphs showing the pleasantness and sensory characteristics (off taste, bitterness, and sweet aftertaste) of the sweetened fiber of the present disclosure, Reb M mixed with dietary fiber, and Reb M alone. Mean±SEM. N=12. Kruskal-Wallis test. Post-hoc Dunn's multiple comparison test: values with different superscript letters are different (P≤0.05). ns—means non-significant differences (P>0.05).

FIG. 7 shows graphs of the mean score of attributes (strength of flavor, bitterness, licorice taste and off-flavor) of sucrose, sweetened fiber of the present disclosure and stevia extract in a 10% solution.

FIG. 8 shows graphs comparing the sweetness and bitterness intensity of the sweetened fiber of the present disclosure and that of sucrose.

FIG. 9 shows graphs comparing the hedonic perception profile of the sweetened fiber of the present disclosure and that of sucrose.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### DESCRIPTION OF VARIOUS EMBODIMENTS

### I. Definitions

Unless otherwise indicated, the definitions and embodiments described in this and other sections are intended to be applicable to all embodiments and aspects of the present disclosure herein described for which they are suitable as would be understood by a person skilled in the art.

The term “composition of the present disclosure” as used herein refers to a composition comprising at least one sweetened fiber of the present disclosure as defined herein, and/or a sweetened fiber composition of the present disclosure as defined herein.

The term “and/or” as used herein means that the listed items are present, or used, individually or in combination. In effect, this term means that “at least one of” or “one or more” of the listed items is used or present. The term “and/or” with respect to pharmaceutically acceptable salts and/or solvates thereof means that the compounds of the disclosure exist as individual salts and hydrates, as well as a combination of, for example, a solvate of a salt of a compound of the disclosure.

As used in the present disclosure, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

As used in this disclosure and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The term “suitable” as used herein means that the selection of the particular compound or conditions would depend on the specific synthetic manipulation to be performed, the identity of the molecule(s) to be transformed and/or the specific use for the compound, but the selection would be well within the skill of a person trained in the art.

All ranges given herein include the end of the ranges and also any intermediate values, whether explicitly stated or not.

In embodiments of the present disclosure, the compounds described herein may have at least one asymmetric center. Where compounds possess more than one asymmetric center, they may exist as diastereomers. It is to be understood that all such isomers and mixtures thereof in any proportion are encompassed within the scope of the present disclosure. It is to be further understood that while the stereochemistry of the compounds may be as shown in any given compound listed herein, such compounds may also contain certain amounts (for example, less than 20%, suitably less than 10%, more suitably less than 5%) of compounds of the present disclosure having an alternate stereochemistry. It is intended that any optical isomers, as separated, pure, or partially purified optical isomers or racemic mixtures thereof are included within the scope of the present disclosure.

The compounds of the present disclosure may also exist in different tautomeric forms, and it is intended that any tautomeric forms which the compounds form, as well as mixtures thereof, are included within the scope of the present disclosure.

The compounds of the present disclosure may further exist in varying polymorphic forms, and it is contemplated that any polymorphs, or mixtures thereof, which form are included within the scope of the present disclosure.

The present description refers to a number of chemical terms and abbreviations used by those skilled in the art. Nevertheless, definitions of selected terms are provided for clarity and consistency.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

The term “atm” as used herein refers to atmosphere.

The term “MS” as used herein refers to mass spectrometry.

The term “aq.” as used herein refers to aqueous.

The term “monosubstituted”, “disubstituted” and “trisubstituted” as used herein in the context of a saccharide monomer refers to the saccharide monomer being attached to one, two and three other saccharide monomers respectively. For example, a disubstituted glucose refers to a glucose monomer in a carbohydrate such as a fiber molecule that is covalently attached to two other saccharide monomers (e.g. glucose monomers) via glycosidic bonds. For example, a trisubstituted glucose refers to a glucose monomer in a fiber molecule that is covalently attached to three other saccharide monomers (e.g. glucose monomers) via glycosidic bonds.

Exemplary structures of disubstituted hexose monomers and trisubstituted hexose monomers are shown in Table A below, where the monomer in dashed boxes is either disubstituted or trisubstituted.

TABLE A
Exemplary structures of disubstituted and trisubstituted hexose monomer

| Disubstitution Pattern | Exemplary Structure |
|---|---|
| 1,2-disubstituted | 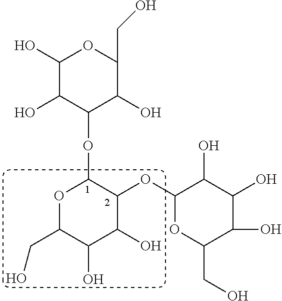 [SMILES: OCC1OC(OC2C(OC3C(O)C(O)OC(CO)C3O)OC(CO)C(O)C2O)C(O)C(O)C1O] |
| 1,3-disubstituted | 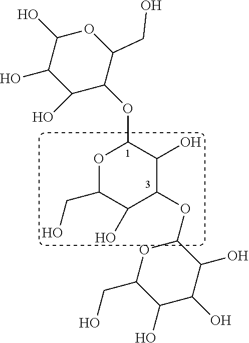 [SMILES: OCC1OC(OC2C(O)C(CO)OC(OC3C(CO)OC(O)C(O)C3O)C2O)C(O)C(O)C1O] |
| 1,4-disubstituted | 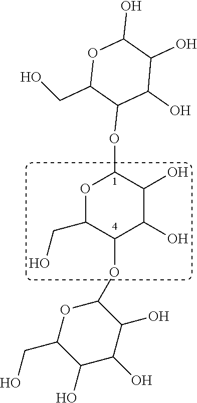 [SMILES: OCC1OC(OC2C(CO)OC(OC3C(CO)OC(O)C(O)C3O)C(O)C2O)C(O)C(O)C1O] |
| 1,6-disubstituted | 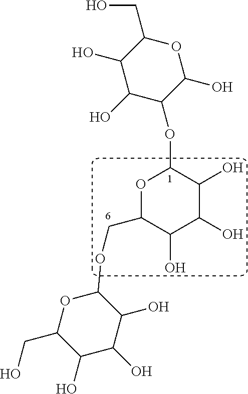 [SMILES: OCC1OC(OCC2OC(OC3C(O)OC(CO)C(O)C3O)C(O)C(O)C2O)C(O)C(O)C1O] |
| Trisubstitution Pattern | Exemplary Structures |
| 1,2,3-trisubstituted | 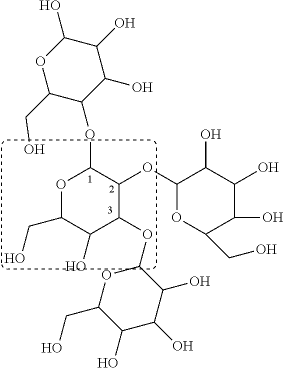 [SMILES: OCC1OC(OC2C(OC3C(CO)OC(O)C(O)C3O)OC(CO)C(O)C2OC2OC(CO)C(O)C(O)C2O)C(O)C(O)C1O] |
| 1,2,4-trisubstituted | 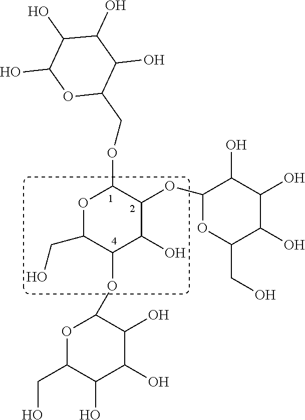 [SMILES: OCC1OC(OC2C(CO)OC(OCC3OC(O)C(O)C(O)C3O)C(OC3OC(CO)C(O)C(O)C3O)C2O)C(O)C(O)C1O] |
| 1,2,6-trisubstituted | 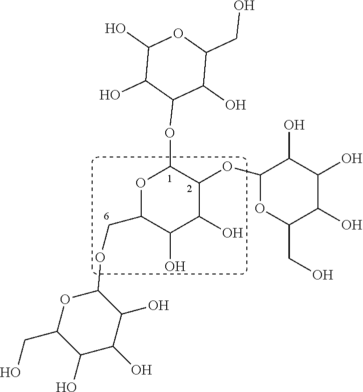 [SMILES: OCC1OC(OCC2OC(OC3C(O)C(O)OC(CO)C3O)C(OC3OC(CO)C(O)C(O)C3O)C(O)C2O)C(O)C(O)C1O] |
| 1,3,4-trisubsituted | 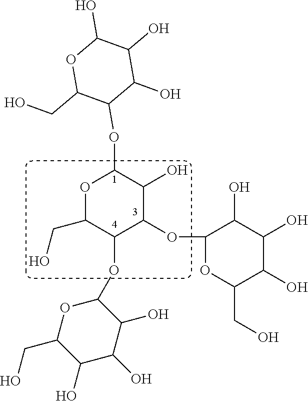 [SMILES: OCC1OC(OC2C(CO)OC(OC3C(CO)OC(O)C(O)C3O)C(O)C2OC2OC(CO)C(O)C(O)C2O)C(O)C(O)C1O] |
| 1,3,6-trisubstituted | 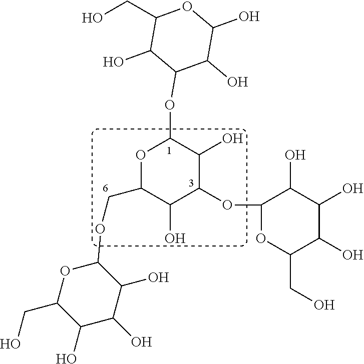 [SMILES: OCC1OC(OCC2OC(OC3C(O)C(O)OC(CO)C3O)C(O)C(OC3OC(CO)C(O)C(O)C3O)C2O)C(O)C(O)C1O] |
| 1,4,6-trisubsituted | 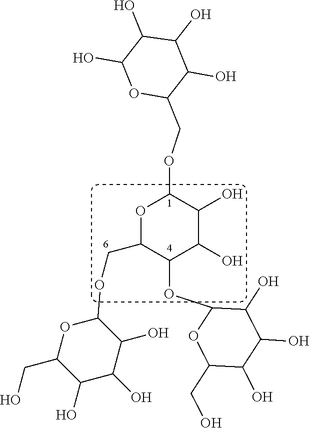 [SMILES: OCC1OC(OCC2OC(OCC3OC(O)C(O)C(O)C3O)C(O)C(O)C2OC2OC(CO)C(O)C(O)C2O)C(O)C(O)C1O] |

It is understood that a saccharide monomer such as glucose monomer has a number of carbon atoms having a hydroxyl group or carbonyl group that can be used to form attachment to another saccharide monomer. For instance, a 1,2-disubstituted glucose refers to a glucose monomer that is attached to two other saccharide monomers, a first saccharide monomer at the C1 position and a second saccharide monomer at the C2 position of the glucose monomer. Similarly, a 1,4-disubstituted glucose refers to a glucose monomer that is attached to two other saccharide monomers, a first saccharide monomer at the C1 position and a second saccharide monomer at the C4 position of the glucose monomer. For example, a 1,2,3-trisubsituted glucose refers to a glucose monomer that is attached to three other saccharide monomers, a first saccharide monomer at the C1 position, a second saccharide monomer at the C2 position, and a third saccharide monomer at the C3 position of the glucose monomer.

The term “saccharide” as used herein is not particularly limited and should be known to a person of ordinary skill in the art. The term “saccharide” includes monosaccharides, disaccharides, oligosaccharides and polysaccharides. The degree of polymerization (DP) relates to the number of monomer units in the oligosaccharide or polysaccharide. For example, a saccharide monomer refers to a monosaccharide or a monomer unit within a disaccharide, oligosaccharide or polysaccharide.

The term “sweetener” as used herein refers to an organic compound that is generally sweet in taste, and that is not sucrose. For example, sweeteners are generally used to impart a sweet taste in edible products. A sweetener can include artificial sweeteners and natural sweeteners such as plant-derived sweeteners. A sweetener can be generally safe for consumption. A sweetener suitable for use according to the present disclosure can have a sweetness intensity that is lower, similar to or greater than that of sucrose depending on the desired sweetness in the sweetened fiber. In some instances, the sweeteners have a sweetness intensity that is greater than that of sucrose. Those sweeteners can be high intensity sweeteners. A sweetener suitable for use according to the present disclosure can have oxygen containing structural moieties that allow for formation of glycosidic bonds. For example, those oxygen-containing moieties can include hydroxyl group and carboxylic acid groups. In some instances, the sweeteners can be glycosylated with one or more saccharide monomer units, which can form glycosidic bonds, for example to the molecules of fiber.

The term “fiber” as used herein refers to a non-digestible, partially digestible, and/or slowly digestible carbohydrate having three or more saccharide monomers. For example, the fiber can have at least 5 saccharide monomers.

The term “derivative thereof” as used herein is not particularly limited and should be known to a person of skill in the art. The derivative of an organic compound is a compound that can be obtained or derived from a similar compound by a chemical reaction, and can involve one atom or group of atoms being replaced with another atom or group of atoms.

The term “glycosidic bond” is a covalent bond that joins the hemiacetal group of a saccharide molecule and a functional group (e.g. oxygen-containing functional group such as hydroxyl group, carboxyl group; sulfur-containing group such as thiol group; nitrogen-containing group such as amine) of another compound that may or may not be another saccharide molecule.

The term “saccharide oligomer(s)” as used herein refers to saccharides comprising at least two saccharide units. For example, saccharides oligomers can have a degree of polymerization (DP) of about 2 to about 200, about 5 to about 150, or about 5 to about 100.

### II. Sweetened Fibers of the Disclosure

In one aspect, the present disclosure includes a sweetened fiber comprising:
a sweetener attached to at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer.

In another aspect, the present disclosure includes a sweetened fiber comprising:
a sweetener attached to at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer, and wherein the trisubstituted saccharide monomer is attached to another saccharide monomer at the C1 position of the trisubstituted saccharide monomer.

In another aspect, the present disclosure includes a sweetened fiber composition comprising:
a fiber, and
a sweetener attached to at least one molecule of the fiber,
wherein each of the at least one molecule of the fiber is attached to the sweetener through an oxygen atom of the sweetener via a glycosidic bond, and
wherein the at least one molecule of the fiber comprises a trisubstituted saccharide monomer.

In another aspect, the present disclosure includes a sweetened fiber composition comprising:
a fiber, and
a sweetener attached to at least one molecule of the fiber,
wherein each of the at least one molecule of the fiber is attached to the sweetener through an oxygen atom of the sweetener via a glycosidic bond, and
wherein the at least one molecule of the fiber comprises a trisubstituted saccharide monomer, and wherein the trisubstituted saccharide monomer is attached to another saccharide monomer at the C1 position of the trisubstituted saccharide monomer.

In another aspect, the present disclosure includes a sweetened fiber comprising:
at least one molecule of fiber, and
a sweetener attached to the at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer.

In another aspect, the present disclosure includes a sweetened fiber comprising:
at least one molecule of fiber, and
a sweetener attached to the at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer, and wherein the trisubstituted saccharide monomer is attached to another saccharide monomer at the C1 position of the trisubstituted saccharide monomer.

In another aspect, the present disclosure includes a sweetened fiber prepared by a method of preparing a sweetened fiber of the present disclosure.

In another aspect, the present disclosure includes a composition comprising at least one of a sweetened fiber of the present disclosure.

In another aspect, the present disclosure includes an edible product comprising the sweetened fiber of the present disclosure.

In another aspect, the present disclosure includes a sweetener product comprising the sweetened fiber of the present disclosure in a packaging.

In some embodiments, the fiber is selected from resistant/modified maltodextrin, polydextrose, β-glucans, galactomannan, fructo-oligosaccharides, gluco-oligosaccharide, galactooligosaccharides, xylooligosaccharides, mannose-oligosaccharides, pectin, psyllium, inulin and inulin-type fructans, resistant starch, isomaltulose, arabinoxylans, alginates, and combinations thereof.

In some embodiments, the fiber is maltodextrin, optionally the fiber is resistant dextrin.

It can be appreciated that depending on the nature of the fiber, and the glycosidic bond connecting the sweetener and the at least one molecules of fiber, the sweetened fiber of the present application may or may not be digestible by a human consumer. It can be understood that gastrointestinal enzymes readily recognize and digest carbohydrates in which the monosaccharide units are linked alpha (1→4) (“linear” linkages). Other linkages, such as (alpha (1→3), alpha (1→6) (“non-linear” linkages), or beta linkages, for example) can reduce the ability of gastrointestinal enzymes to digest the carbohydrate. This can allow the carbohydrates to pass on into the small intestines largely unchanged. The glycosidic bonds present in the sweetened fibers of the present disclosure (e.g. in the fiber or between the fiber and the sweetener) can be selected from α 1→2, α 1→3, α 1→4, α 1→6, β1-2, β1-3, β1-4, β1→6 covalent linkage, and combinations thereof. Thus, it can be appreciated that depending on the proportion of different glycosidic linkages the sweetened fiber of the present disclosure can be digestible, digestion-resistant, slowly digestible, or partially digestible.

The fiber described herein can be an insoluble fiber or a soluble fiber. In some embodiments, it is a soluble fiber. It is contemplated that the sweetened fiber of the present disclosure can comprise soluble fiber, insoluble fiber, or a mixture of both. Accordingly, without wishing to be bound by theory, the solubility of the sweetened fiber may be adjusted depending on the solubility of the fiber used to prepare the sweetened fiber. For instance, when the sweetened fiber comprises molecules of a soluble fiber, the sweetened fiber is likely to remain soluble as well. For example, when the sweetened fiber comprises molecules of an insoluble fiber, the sweetened fiber is likely to remain insoluble as well. It is also contemplated that a mixture of soluble and insoluble fibers can be used to prepare the sweetened fiber of the present disclosure, in which case, without wishing to be bound by theory, the solubility of the sweetened fiber may depend on the proportion of soluble and insoluble fibers. Thus, the proportions of each can depend on the fiber requirements for the final composition.

In some embodiments, the sweetened fiber is water soluble. In some embodiments, wherein the sweetened fiber has a solubility of about 100 g/100 mL to about 250 g/100 mL, about 120 g/100 mL to about 200 g/100 mL, about 140 g/100 mL to about 180 g/100 mL, or about 160 g/100 mL in water at room temperature.

The fiber described herein can be any suitable fiber. Examples of the fiber suitable for use in the sweetened fiber described herein include those derived from a variety of food sources, including cereal grains, potatoes, yams, carrots, bananas, plantains, pumpkins, tapioca and combinations thereof. The fiber can be derived from any of a variety of cereal grains, such as corn, wheat, oats, rice, barley, and combinations thereof. The fiber may be derived from a variety of plant and root sources, such as chicory, Jerusalem artichoke, and cassava; or a variety of legumes, such as beans, lentils, and peas; or a variety of grain-like starchy fruits, such as quinoa and buckwheat. In some embodiments, the fiber is derived from tapioca. In some embodiments, the fiber is derived from corn. In some embodiments, the fiber is a soluble corn fiber. In some embodiments, the fiber is not derived from a genetically modified organism (GMO). For example, the fiber may be derived from a non-GMO corn. In some embodiments, the sweetened fiber may contain about 60% to about 95% by weight fiber on a dry solids basis, such as about 60%, about 65%, about 70%, about 75%, about 80%, about 85%, or about 90%, to about 65%, about 70%, about 75%, about 80%, about 85%, about 90% or about 95% by weight of the fiber on a dry solids basis. In some embodiments, the sweetened fiber contains a major amount of fiber on a dry solid basis. In other words, excluding any water that is present, the percentage of fiber that is present in the sweetener composition is greater than or equal to the percentage of any other ingredient. Thus, the sweetened fiber of the present disclosure can make for a high fiber substitute and/or addition to a food product.

The fiber is typically a saccharide oligomer. In aspects, the saccharide oligomer can be a linear saccharide oligomer, a non-linear saccharide oligomer or a combination thereof. The average DP of the saccharide oligomers described herein may be about 5, about 6, about 7, about 8, about 9, about 10, about 11, about 12, about 13, about 14, about 15, about 16, about 17, about 18, about 19, about 20, about 21, about 22, about 23, about 24, about 25, about 26, about 27, about 28, about 29, or about 30. In some embodiments, the fiber comprises at least 5 saccharide monomers. In some embodiments, the fiber comprises about 5 to about 160 saccharide monomers. It is appreciated that a fiber can comprise a range or a distribution of DP. For example, the fiber can comprise a DP ranging from about 5 to about 200, about 6 to about 160, about 9 to about 180. For example, the fiber can have a DP of at least 5, at least 6, at least 7, at least 8, at least 9, or at least 10. For example, the fiber can have a DP of less than 200, less than 180, less than 170, less than 160, less than 150, less than 130, less than 100, less than 50, or less than 30.

With reference to the sweetened fiber being slowly digestible or digestion-resistant, a “slowly digestible” sweetened fiber may contain a substantial quantity (e.g., at least about 50% on a dry solids basis, and in some cases at least about 75%, or at least about 90%) of the saccharide oligomers present in the molecules of the fiber that are either not digested at all in the human stomach and small intestine or are only digested to a limited extent. In some embodiments, the sweetened fiber is substantially resistant to digestion by the human digestive system. In some embodiments, the sweetened fibers are digestion resistant and slowly digestible, such that a combination of each type of fiber is present in compositions comprising the compound described herein. Both in vitro and in vivo tests can be performed to estimate the rate and extent of carbohydrate digestion in humans. The “Englyst Assay” is an in vitro enzyme test that can be used to estimate the amounts of a carbohydrate ingredient that are rapidly digestible, slowly digestible, or resistant to digestion (European Journal of Clinical Nutrition (1992) Volume 46 (Suppl. 2), pages S33-S50). Thus, any reference herein to “at least about 50% by weight on a dry solid basis” of a material being slowly digestible, or to a material being “primarily slowly digestible,” means that the sum of the percentages that are classified as slowly digestible or as resistant by the Englyst assay totals at least about 50%. Likewise, any reference herein to “at least about 50% by weight on a dry solids basis” of a material being digestion-resistant or to a material being “primarily digestion-resistant,” means that the percentage that is classified as resistant by the Englyst assay is at least about 50%.

In some embodiments, the fiber is a resistant and/or indigestible dextrin. In some embodiments, the fiber is a resistant maltodextrin. In some embodiments, the fiber is a resistant dextrin derived from corn, tapioca, and/or mixtures thereof. For example, the fiber can be resistant corn dextrin or resistant tapioca dextrin.

It is appreciated that resistant dextrin is a specialty dextrin that can be produced using a starch hydrolysis and transglucosidation/repolymerization, followed by a series of purification and spray drying. This process produces an indigestible, mostly soluble dextrin with an elevated fiber content. Thus, it belongs to the non-digestible carbohydrates or fiber category. It can be odorless and white or almost white. It can be derived from either corn, tapioca or another starch-rich feed stock.

Resistant dextrin can be made from corn, wheat, and/or tapioca starch by pyrodextrinization with or without enzyme treatments. Some commercially available resistant dextrin products that can be used with the methods of the present disclosure to prepare the sweetened fiber of the present disclosure include but are not limited to FiberSMART™ NUTRIOSE™ (NUTRIOSE FM, derived from corn, NUTRIOSE FB derived from wheat, AGG and Roquette), Fibersol-2™ and ‘Pinefibre-C™ (Matsutani Chemical Industry), Promitor™ (Tate & Lyle).

Other resistant dextrin type fibers that can be used include polydextrose and isomaltodextrin based fibers prepared using enzymatic or dehydration synthesis.

In some embodiments, the sweetener is glycosylated. In some embodiments, the at least one molecule of fiber is attached to a glucose on the glycosylated sweetener.

In some embodiments, the sweetener is a natural sweetener. In some embodiments, the sweetener is a diterpene, triterpene or mixture thereof.

In some embodiments, the diterpene is a steviol, and/or steviol glycoside. In some embodiments, the steviol glycoside is selected from dulcoside A, rebaudioside, steviolmonoside, steviol-19-O-β-D-glucoside, rubusoside, steviolbioside, stevioside, stevioside A, stevioside B, and mixtures thereof. In some embodiments, the rebaudioside is selected from rebaudioside A, rebaudioside B, rebaudioside G, rebaudioside E, rebaudioside D, rebaudioside I, rebaudioside L, rebaudioside Q2, rebaudioside Q, rebaudioside I2, rebaudioside Q3, rebaudioside I3, rebaudioside M, and mixtures thereof. In some embodiments, the sweetener is rebaudioside M, and/or rebaudioside A.

In some embodiments, the triterpene is selected from mogroside V, mogroside IVa, mogroside IVe, aglycyrrhizin and mixtures thereof.

In some embodiments, the sweetener is a synthetic sweetener, optionally the synthetic sweetener is selected from advantame, neotame, sucralose, aspartame, and combinations thereof.

Advantame refers to an artificial sweetener of the structure below

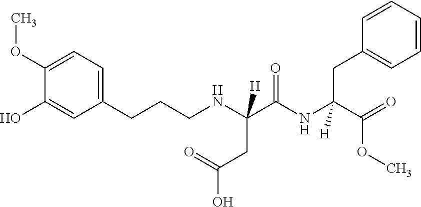 [SMILES: COC(=O)[C@H](Cc1ccccc1)NC(=O)[C@H](CC(=O)O)NCCCc1ccc(OC)c(O)c1]

or a salt thereof.

Neotame refers to an artificial sweetener of the structure below

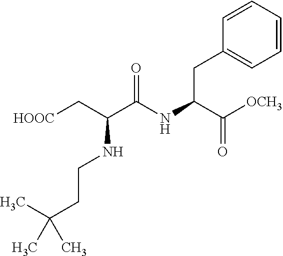 [SMILES: COC(=O)[C@H](Cc1ccccc1)NC(=O)[C@H](CC(=O)O)NCCC(C)(C)C]

or a salt thereof.

Sucralose refers to an artificial sweetener of the structure below

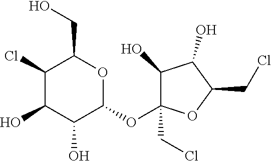 [SMILES: OC[C@H]1O[C@H](O[C@]2(CCl)O[C@H](CCl)[C@@H](O)[C@@H]2O)[C@H](O)[C@@H](O)[C@H]1Cl]

or a salt thereof.

Aspartame refers to an artificial sweetener of the structure below

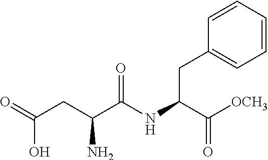 [SMILES: COC(=O)[C@H](Cc1ccccc1)NC(=O)[C@@H](N)CC(=O)O]

or a salt thereof.

In some embodiments, the sweetener is attached to one or a plurality, for example two or at least two molecules, or more of fiber. In some embodiments, the sweetener is attached to one or more molecules of fiber. In some embodiments, more than one sweetener is attached to a given molecule of fiber.

The sweetener can be, for example and without limitation, steviol glycoside, sucralose, aspartame, Siraitia grosvenori extract, Glycyrrhiza uralensis Fischer extract, thaumatin, and agave syrup, a modified monosaccharide, a modified disaccharide, or derivatives thereof.

In some embodiments, the sweetener is a stevia extract. In some embodiments, the sweetener is a modified stevia extract. In some embodiments, the sweetener is a glycosylated steviol glycoside, and/or steviol glycoside.

Steviol glycosides are a family of sweeteners derived from the plant Stevia rebaudiana. Steviol glycosides have the general structure

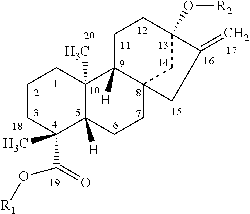

where R₁ and R₂ are exemplified in Table B below.

TABLE B
Structure of common steviol glycosides

| Common Name | R₁ | R₂ |
|---|---|---|
| Steviolmonoside | H | Glcβ1- |
| Steviol-19-O-β-D- | Glcβ1- | H |
| glucoside | | |
| Rubusoside | Glcβ1- | Glcβ1- |
| Steviolbioside | H | Glcβ(1-2)Glcβ1- |
| Stevioside | Glcβ1- | Glcβ(1-2)Glcβ1- |
| Stevioside A | Glcβ(1-2)Glcβ1- | Glcβ1- |
| Rebaudioside B | H | Glcβ(1-2)[Glcβ(1-3)]Glcβ1- |
| Rebaudioside G | Glcβ1- | Glcβ(1-3)Glcβ1- |
| Stevioside B | Glcβ(1-3)Glcβ1- | Glcβ1- |
| Rebaudioside E | Glcβ(1-2)Glcβ1- | Glcβ(1-2)Glcβ1- |
| Rebaudioside A | Glcβ1- | Glcβ(1-2)[Glcβ(1-3)]Glcβ1- |
| Rebaudioside A2 | Glcβ1- | Glcβ(1-6)Glcβ(1-2)Glcβ1- |
| Rebaudioside D | Glcβ(1-2)Glcβ1- | Glcβ(1-2)[Glcβ(1-3)]Glcβ1- |
| Rebaudioside I | Glcβ(1-3)Glcβ1- | Glcβ(1-2)[Glcβ(1-3)]Glcβ1- |
| Rebaudioside L | Glcβ1- | Glcβ(1-6)Glcβ(1-2)[Glcβ(1- |
| | | 3)]Glcβ1- |
| Rebaudioside Q2 | Glcα(1-2)Glcα(1-4)Glcβ1- | Glcβ(1-2)Glcβ1- |
| Rebaudioside Q | Glcβ1- | Glcα(1-4)Glcβ(1-2)[Glcβ(1- |
| | | 3)]Glcβ1- |
| Rebaudioside I2 | Glcβ1- | Glcα(1-3)Glcβ(1-2)[Glcβ(1- |
| | | 3)]Glcβ1- |
| Rebaudioside Q3 | Glcβ1- | Glcα(1-4)Glcβ(1-3)[Glcβ(1- |
| | | 2)]Glcβ1- |
| Rebaudioside I3 | Glcβ(1-2)[Glcβ(1- | Glcβ(1-2)Glcβ1- |
| | 6)]Glcβ1- | |
| Rebaudioside M | Glcβ(1-2)[Glcβ (1- | Glcβ(1-2)[Glcβ(1-3)]Glcβ1- |
| | 3)]Glcβ1- | |

It is contemplated that any steviol glycoside including but not limited to those listed above may be used in the sweetened fiber of the present disclosure and/or in the methods of the present disclosure.

It can be appreciated that when a natural sweetener is used, the sweetened fiber can comprise more sweetener compared to when a synthetic sweetener is used, since synthetic sweeteners are typically over 1000 times sweeter than sucrose. According, in some instances, when the sweetener is a natural sweetener, the sweetened fiber can comprise more than 1% w/w, more than 1.5% w/w, more than 2% w/w, or more than 4% w/w of the sweetener. In some embodiments, the sweetened fiber comprises about 1% w/w to about 30% w/w, about 1% w/w to about 20% w/w, 2% w/w to about 20% w/w, about 2% w/w to about 15% w/w, or about 4% w/w to about 10% w/w of the sweetener. In some embodiments, the sweetened fiber comprises about 70% w/w to about 99% w/w of the fiber, and about 1% w/w to about 30% w/w of sweetener. In some embodiments, the sweetened fiber comprises about 80% w/w to about 99% w/w of the fiber, and about 1% w/w to about 20% w/w of sweetener. In some embodiments, the sweetened fiber comprises about 90% w/w to about 99% w/w of the fiber, and about 1% w/w to about 10% w/w of sweetener. In some embodiments, the sweetened fiber comprises about 95% w/w to about 99% w/w of the fiber, and about 1% w/w to about 5% w/w of sweetener. In some embodiments, the sweetened fiber comprises about 98% w/w to about 99% w/w of the fiber and about 1% w/w to about 2% w/w of sweetener.

In some embodiments, when the sweetener is a steviol glycoside, the sweetened fiber comprises about 0.3 g to about 1 g, about 0.4 g to about 0.8 g, about 0.5 g to about 0.7 g, or about 0.5 of steviol glycoside per 100 g of the sweetened fiber.

By the same reasoning, when an artificial sweetener is used, the sweetened fiber can comprise less sweetener by weight relative to a natural sweetener. For instance, when the sweetener is an artificial sweetener, the sweetened fiber can comprise less than 1% w/w, less than 0.7% w/w, less than 0.5% w/w, less than 0.1% w/w. less than 0.07% w/w, less than 0.05% w/w, less than 0.02% w/w, or less than 0.01% w/w of the sweetener.

It is known that as the number of monomers in a saccharide molecule increases, the sweetness of the saccharide molecule decreases. (LWT-Food Science and Technology, 2018, 97, pages 476-482 incorporated herein by reference). For example, disaccharides typically have a higher sweetness intensity than trisaccharides, and oligosaccharides tend to have a lower sweetness intensity than tri-saccharides and di-saccharides generally. In general, oligosaccharides over three units of saccharide monomer do not tend to have noticeable sweetness. However, it has been shown herein that the sweetened fibers of the present disclosure, while having molecules of fibers of significant length, (e.g. average DP of over 20), can still have a sweet taste with sweetness intensity that is tunable to be similar to that of sucrose.

In some embodiments, the sweetened fiber has a polydispersity index (PDI) of about 1.25 to about 1.48, about 1.35 to about 1.48, about 1.40 to about 1.45, about 1.42 to about 1.44, or about 1.438.

In some embodiments, the sweetened fiber has an average degree of polymerization (DP) of more than about 5, more than about 6, more than about 7, more than about 8, more than about 10, more than about 15, or more than about 20. In some embodiments, the sweetened fiber has an average DP of less than about 50, less than about 45, less than about 40, less than about 35, less than about 30, less than about 25, less than about 20, less than about 15, or less than about 10.

In some embodiments, the sweetened fiber has an average degree of polymerization (DP) of about 19 to about 30, about 20 to about 28, about 25 to about 27, about 26 to about 27, or about 26.87.

In some embodiments, the sweetened fiber has a DP of about 6 to about 154, about 6 to about 92, about 9 to about 99, or about 9 to about 44.

In some embodiments, each of the at least one molecule of fiber has a DP of about 11 to about 86.

It is contemplated that depending on the desired sweetness intensity, the sweetened fiber of the present disclosure can be adjusted to achieve the desired sweetness intensity. For example, without wishing to be bound by theory, the sweetness intensity of the sweetened fiber can be adjusted by using less sweetener in the preparation of the sweetened fiber as described herein. Further, it is also contemplated that the reaction conditions of preparing the sweetened fiber may be adjusted to achieve a desirable fiber size and number attached to the sweetener to lead to the desired sweetness intensity. For example, it can be appreciated that, as explained herein, as the size and number of fiber molecules attached to the sweetener increase, the sweetness intensity decreases. As such, by increasing the reaction time in the reaction of the sweetener and the fiber, more fiber molecules may be attached to the sweetener and/or larger fiber molecules may be allowed to attach to the sweetener, leading to sweetened fiber that is less sweet. Moreover, it is contemplated that water can be combined with the sweetener and the fiber during the reaction to facilitate hydrolysis and glycosylation of the fiber and the sweetener, allowing for more fiber molecules and/or larger fiber molecules to be attached to the sweetener.

In some embodiments, the sweetener, or derivative thereof, has a sweetness intensity greater than 30 times, 60 times, 90 times, 100 times, 200 times, 250 times, 300 times, 400 times, 500 times, 600 times, 700 times, 800 times, 900 times, 1000 times, or more than a 1000 times, the sweetness intensity of sucrose. In some embodiments, the sweetened fiber of the present disclosure has substantially the same sweetness intensity as sucrose. In some embodiments, the sweetened fiber of the present disclosure has a higher sweetness intensity than sucrose. In some embodiments, the sweetened fiber of the present disclosure has a lower sweetness intensity than sucrose. In some embodiments, the sweetened fiber of the present disclosure has a sweetness intensity (or equivalence) of at least 70% of sucrose, such as at least 75%, at least 80%, at least 85%, at least 90%, at least 95%, about 100% of sucrose, about 105% of sucrose, about 110% of sucrose, about 115% of sucrose, about 120% of sucrose, or about 130% of sucrose. In some embodiments, the sweetened fiber of the present disclosure has a sweetness intensity (equivalence) is about 95% to about 100% of sucrose. In some embodiments, the sweetened fiber and/or a composition of the present disclosure has substantially the same sweetness intensity as sucrose.

In some embodiments, the sweetened fiber and/or a composition of the present disclosure has a sweetness intensity that is about 80% to about 90%, about 85 to about 95%, about 95% to about 100%, about 80%, about 90%, about 95%, or about 100% of that of sucrose.

In some embodiments, the sweetened fiber and/or a composition of the present disclosure has a sweetness intensity that is higher than that of sucrose. In some embodiments, the sweetness intensity of the sweetened fiber is about 110% to about 300%, or about 150% to about 200% of that of sucrose.

A known undesirable characteristic of many commercially available sweeteners is the lingering aftertaste. The aftertaste can lead to a sweetness intensity that remains undesirably high even long after the consumption of the sweetener. The aftertaste can also make the sweetener tastes unnatural to a consumer compared to natural sugar. This effect is thought to be caused by the tight binding of sweetener molecules onto the sweetness receptor, leading the receptor to be constantly activated. Without wishing to be bound by theory, the sweetened fiber while capable of binding to the sweet taste receptor in a subject through the sweetener moiety and thus triggering a sweet taste, also contains fiber molecules that are relatively large in size. Specifically, compared to natural fibers and other commercial fibers, the sweetened fibers of the present disclosure have a higher degree of branching due to the presence of trisubstituted saccharide monomers and less terminal saccharides. As such, the high branching nature increases the steric hindrance proximal to the sweetener moiety, which prevents the sweetener moiety from binding the sweetness receptor undesirably tightly. Thus, the sweetened fiber of the present disclosure dissociates from the sweetness receptor after activating the latter more readily than traditional sweeteners. Accordingly, the sweetened fiber and/or composition of the present disclosure has a sweet taste that is more natural than the sweetener and more comparable to natural sugar. Accordingly, in some embodiments, the sweetened fiber of the present disclosure has substantially the same lingering time of sweetness as sucrose. In some embodiments, the sweetened fiber of the present disclosure has less lingering time of sweetness and/or aftertaste than the sweetener. In some embodiments, when the sweetened fiber of the present disclosure is added to/included in an edible product, such as chocolate, the sweetened fiber of the present disclosure allows for substantially the same amount of time for the sweet taste sensation as would be detected by a consumer who was consuming the same edible product containing sucrose. In some embodiments, the sweetened fiber of the present disclosure provides for substantially the same onset time to detecting sweetness as sucrose, such that, for example, when an edible product containing the sweetened fiber of the present disclosure is consumed, the consumer would have the same sweet sensation at the same onset time, as if the consumer was consuming an edible product with sucrose. In some embodiments, the sweetened fiber of the present disclosure has a relative sweetness of about 95% to about 100% compared to sucrose, and it can function as an equivalent sweet substitute for sucrose when used in a food or beverage product formulation.

It can be appreciated that the trisubstitution of saccharide monomers is less frequent in nature since enzymatic formation of glycosidic bonds is usually limited to disubstitution. It is known that glycosyltransferases generally form 1→4 glycosidic bonds and only under very specific laboratory conditions would form 1→3 and 1→6 glycosidic bonds. Glycosyltransferases also do not tend to form trisubstituted saccharides. Accordingly, the trisubstituted saccharide monomers observed at the levels in the sweetened fiber of the present disclosure cannot be achieved by enzymatic transformations and are unique from fibers from pyrodextrinization.

As shown herein, the sweetened fiber of the present disclosure has been shown to have an increased content of trisubstituted saccharide monomers. For example, a 500% increase in 1,2,3-trisubstituted monomers, 250% increase in 1,2,4-trisubstituted monomers, 340% increase in 1,3,6-trisubstituted monomers, and/or 300% 1,4,6-trisubstituted monomers were observed in the exemplary sweetened fiber relative to the starting material fiber. (See for example Table 2 of Example 2)

It has been shown as described below that the sweetened fiber of the present disclosure comprises different types of glycosidic linkages selected from can be selected from α1→2, α1→3, α1→4, α1→6, β1→2, β1→3, β1→4, β1→6 and combinations thereof. In some embodiments, the sweetened fiber of the present disclosure comprises about 60% to about 70% of α glycosidic linkages, and about 30% to about 40% β glycosidic linkages. For example, the sweetened fiber of the present disclosure comprises about 65% of α glycosidic linkages, and about 35% β glycosidic linkages. In some embodiments, the sweetened fiber of the present disclosure comprises about 10% to about 48% α 1→4 linkages based on total glycosidic linkages in the sweetened fiber. In some embodiments, the sweetened fiber of the present disclosure comprises about 16% to about 21% α 1→6 linkages based on total glycosidic linkages in the sweetened fiber. In some embodiments, the sweetened fiber of the present disclosure comprises about 2.1% to about 4.1% α 1→2 linkages based on total glycosidic linkages in the sweetened fiber.

In some embodiment, the at least one molecule of fiber comprises disubstituted saccharide monomer. It can be appreciated that the nature of the saccharide monomers in the at least one molecule of fiber depends on the nature of the fiber. For example, when the fiber is dextrin or resistant dextrin, the saccharide monomers are predominantly glucose. For example, when the fiber is inulin, the saccharide monomers can be predominantly glucose and fructose. For example, when the fiber is galactomannan based, the saccharide monomers can be predominantly galactose and mannose. Accordingly, the sweetened fiber may comprise trisubstituted galactose, trisubstituted mannose, trisubstituted fructose, trisubstituted, allulose, or other trisubstituted saccharide monomers as the case may be.

Similarly, it is may be that different di- and/or trisubstitution patterns have been seen. In some embodiments, the at least one molecule of fiber comprises disubstituted saccharide monomer. For example, the disubstituted saccharide monomer is selected from 1,3-disubstituted glucose, 1,2-disubstituted saccharide monomer, 1,4-disubstituted saccharide monomer, 1,6-disubstituted saccharide monomer and combinations thereof. In some embodiments, the at least one molecule of fiber comprises a trisubstituted saccharide monomer. It can be appreciated that as described herein, the trisubstituted saccharide monomer is attached to three other saccharide monomers. In some embodiments, the trisubstituted saccharide monomer is attached to another saccharide monomer at the C1 position of the trisubstituted monomer. In some embodiments, the trisubstituted saccharide monomer is selected from 1,3,4-trisubstituted saccharide monomer, 1,2,3-trisubstituted saccharide monomer, 1,2,4-trisubstituted saccharide monomer, 1,3,6-trisubstituted saccharide monomer, 1,4,6-trisubstituted saccharide monomer, 1,2,6-trisubstituted saccharide monomer, and combinations thereof.

In some embodiments, the saccharide monomer directly attached to the sweetener is monosubstituted or disubstituted. For example, when the sweetener is a steviol based sweetener, the saccharide monomer(s) attached to the steviol core is/are monosubstituted and/or disubstituted.

In some embodiments, the fiber comprises glucose monomers. In some embodiments, the at least one molecule of fiber comprises about 32% to 38% terminal glucose based on the total amount of glucose units in the at least one molecule of fiber.

In some embodiments, the at least one molecule of fiber comprises about 46% to about 50% di-substituted glucose based on the total amount of glucose units in the at least one molecule of fiber.

In some embodiments, the disubstituted glucose is selected from 1,3-disubstituted glucose, 1,2-disubstituted glucose, 1,4-disubstituted glucose, 1,6-disubstituted glucose, and combinations thereof.

In some embodiments, the at least one molecule of fiber comprises about 6.7% to about 7.1% of 1,3-disubstituted glucose based on the total amount of glucose units in the at least one molecule of fiber. In some embodiments, the at least one molecule of fiber comprises about 4.8% to about 5.2% of 1,2-disubstituted glucose based on the total amount of glucose units in the at least one molecule of fiber. In some embodiments, the at least one molecule of fiber comprises about 22.1% to about 23.7% of 1,6-disubstituted glucose based on the total amount of glucose units in the at least one molecule of fiber. In some embodiments, the at least one molecule of the fiber comprises about 12.8% to about 13.6% of 1,4-disubstituted glucose based on the total amount of glucose units in the at least one molecule of fiber.

In some embodiments, the sweetened fiber has a MW of about 1000 Da to about 7000 Da, about 2000 Da to about 6000 Da, about 3000 Da to about 5000 Da, about 4000 Da to about 5000 Da, about 4000 Da to about 4500 Da, or about 4100 Da to about 4400 Da, or about 4375 DA.

In some embodiments, the sweetened fiber has a number average molecular weight (Mn) of about 900 Da to about 4500 Da, about 1500 Da to about 4000 Da, about 2000 Da to about 3500 Da, about 2500 Da to about 3500 Da, about 2700 Da to about 3200 Da, about 2900 Da to about 3100 Da, or about 3041 Da.

In some embodiments, the at least one molecule of fiber comprises trisubstituted glucose.

In some embodiments, the tri-substituted glucose is selected from 1,3,4-trisubstituted glucose, 1,2,3-trisubstituted glucose, 1,2,4-trisubstituted glucose, 1,3,6-trisubstituted glucose, 1,4,6-trisubstituted glucose, 1,2,6-trisubstituted glucose, and combinations thereof.

In some embodiments, the at least one molecule of fiber comprises about 14% to about 17% trisubstituted glucose based on the total amount of glucose units in the at least one molecule of fiber. In some embodiments, the at least one molecule of fiber comprises about 0.4% to about 1.2% of 1,3,4-trisubstituted glucose based on the total amount of glucose units in the at least one molecule of fiber. In some embodiments, the at least one molecule of fiber comprises about 1.4% to about 1.6% of 1,2,3-trisubstituted glucose based on the total amount of glucose units in the at least one molecule of fiber. In some embodiments, the at least one molecule of fiber comprises about 1.4% to about 1.6% of 1,2,4-trisubstituted glucose based on the total amount of glucose units in the at least one molecule of fiber. In some embodiments, the at least one molecule of fiber comprises about 3.1% to about 4.3% of 1,3,6-trisubstituted glucose based on the total amount of glucose units in the at least one molecule of fiber. In some embodiments, the at least one molecule of fiber comprises about 5.8% to about 6.4% of 1,4,6-trisubstituted glucose based on the total amount of glucose units in the at least one molecule of fiber. In some embodiments, the at least one molecule of fiber comprises about 2.2% to about 2.6% of 1,2,6-trisubstituted glucose based on the total amount of glucose units in the at least one molecule of fiber.

In some embodiments, the composition of the present disclosure comprising at least one of a sweetened fiber of the present disclosure further comprises a carrier, such as a pharmaceutically acceptable or food-grade carrier.

In some embodiments, the composition further comprises an additive. Optionally, the additive can be selected from colorant, flavour, preservative, and combinations thereof. In some embodiments, the carrier can include a non-toxic solvent, dispersant, excipient, adjuvant and/or filler.

In some embodiments, the composition further comprises additional fiber.

The composition of the present disclosure comprises the fiber and/or the at least one molecule of fiber. Thus, in some embodiments, the composition of the present disclosure comprises the saccharide monomers (e.g. glucose) as described herein. For example, the composition of the present disclosure comprises saccharide monomers (e.g glucose) with disubstitution and/or trisubstitution pattern as described herein.

In some embodiments, the composition is substantially free of unreacted sweetener (e.g. free sweetener that is not attached to a molecule of fiber). In some embodiments, the composition comprises less than about 3% w/w, less than about 2% w/w, less than about 1% w/w, less than about 0.5% w/w, less than about 0.3% w/w, less than about 0.1% w/w free sweetener based on the weight of the composition. In some embodiments, the composition comprises about 0.05% w/w, about 0.07% w/w, or about 0.1% w/w of free sweetener based on the weight of the composition.

In some embodiments, the composition of the present disclosure comprises about 0.5% w/w to about 18% w/w, about 0.5% to about 15% w/w, about 1% w/w to about 13% w/w, about 3% w/w to about 13% w/w, about 5% w/w to about 12% w/w, about 8% w/w to about 10% w/w of fiber (e.g. fiber that is not attached to any sweetener) based on the weight of the composition. In some embodiments, the composition of the present disclosure comprises more than 0.1% w/w, more than 0.5% w/w, more than 1% w/w, more than 3% w/w, more than 5% w/w, more than 8% w/w, more than 10% w/w, more than 12% w/w, more than 13% w/w, more than 15% w/w, more than 18% w/w of fiber based on the weight of the composition. In some embodiments, the composition of the present disclosure comprises about less than 20% w/w, less than 18% w/w, less than 15% w/w, less than 13% w/w, less than 12% w/w, less than 10% w/w, less than 10% w/w, less than 8% w/w, less than 5% w/w, less than 3% w/w, less than 1% w/w, less than 0.5% w/w or less than 0.3% w/w of fiber based on the weight of the composition.

In some embodiments, the composition of the present disclosure has a bulk density of about 0.3 g/L to about 0.7 g/L, about 0.4 g/L, to about 0.6 g/L, or about 0.5 g/L to about 0.6 g/L. In some embodiments, the composition of the present disclosure has a bulk density of about 0.54 g/L.

In some embodiments, the composition of the present disclosure has a moisture content of less than about 10%, less than about 9%, less than about 8%, less than about 7%, less than about 6%, less than about 5%, less than about 3%, less than about 1%, or less than about 0.9%. In some embodiments, the composition of the present disclosure has a moisture content of more than about 0.1%, more than about 0.3%, more than about 0.5%, more than about 0.7%, more than about 1%, more than about 3%, more than about 5%, or more than about 6%. In some embodiments, the composition of present disclosure has a moisture content of about 0.1% to about 6%, about 0.2% to about 3%, about 0.5% to about 1%, about 0.6% to about 0.9%, or about 0.7% to about 0.8%.

In some embodiments, the composition of the present disclosure has a caloric content of about 0.5 kcal/g to about 10 kcal/g, about 0.5 kcal/g to about 7 kcal/g, about 0.5 kcal/g to about 6 kcal/g, or about 1 kcal/g to about 5 kcal/g.

In some embodiments, the composition of the present disclosure further comprises additional fiber, e.g. fiber that is not attached to the sweetener. The additional fiber can be a bulking agent, e.g. bulking fiber. It may be that when fiber is used in excess of the sweetener in a method of preparing the sweetened fiber of the present disclosure, the excess fiber may undergo chemical transformation during the method to for example depolymerize and/or repolymerize, and/or to have more trisubstituted saccharide monomers. It may also be that a portion of the excess fiber would remain unchanged and unreacted. The excess fiber may be purified and removed from the sweetened fiber if desired. The excess fiber may also be kept with the sweetened fiber to for example provide additional fiber content. It has been shown that the excess fiber after an exemplary method of preparing the sweetened fiber of the present disclosure can be about 8% w/w to about 35% w/w, or about 10% w/w to about 29% w/w of the composition. Extra fiber may also be added to a purified or unpurified sweetened fiber of the present disclosure to provide additional fiber. Thus, it is envisioned that the additional fiber in the composition of the present disclosure can include any of the possible fibers described herein.

In some embodiments, the composition of the present disclosure comprises about 40:1 to about 400:1, about 50:1 to about 350:1, about 60:1 to about 300:1, about 70:1 to about 300:1, about 90:1 to about 300:1, about 100:1 to about 300:1 of fiber (e.g. fiber not attached to sweetener) to free sweetener (e.g. not attached to fiber) by weight. In some embodiments, the composition of the present disclosure comprises more than about 40:1, more than about 50:1, more than about 60:1, more than about 70:1, more than about 80:1, more than about 90:1, more than about 100:1, more than about 150:1, more than about 170:1, more than about 190:1, more than about 200:1, more than about 230:1, more than about 250:1, or more than about 290:1 of fiber (e.g. fiber not attached to sweetener) to free sweetener (e.g. not attached to fiber) by weight. In some embodiments, the composition of the present disclosure comprises more than 80:1 of fiber (e.g. fiber not attached to sweetener) to free sweetener (e.g. not attached to fiber) by weight. In some embodiments, the composition of the present disclosure comprises less than about 500:1, less than about 450:1, less than about 400:1, less than about 380:1, less than about 360:1, less than about 350:1, less than about 330:1, less than about 300:1, less than about 270:1, less than about 250:1, less than about 220:1, less than about 200:1, less than about 170:1, less than about 150:1 of fiber (e.g. fiber not attached to sweetener) to free sweetener (e.g. not attached to fiber) by weight.

In some embodiments, the composition of the present disclosure comprises about 60% w/w to about 95% w/w, about 65% w/w to about 95% w/w, or about 70% w/w to about 93% w/w of the sweetened fiber of the present disclosure. In some embodiments, the composition of the present disclosure comprises more than about 50% w/w, more than about 55% w/w, more than about 60% w/w, more than about 65% w/w, more than about 70% w/w, more than about 75% w/w, more than about 80% w/w, more than about 85% w/w, more than about 90% w/w, or more than about 95% w/w of the sweetened fiber of the present disclosure. In some embodiments, the composition of the present disclosure comprises less than about 95% w/w, less than about 90% w/w, less than about 85% w/w, less than about 80% w/w, less than about 75% w/w, less than about 70% w/w, less than about 65% w/w, or less than about 60% w/w of the sweetened fiber of the present disclosure. The weight ratio of the sweetener to the fiber content of the sweetened fiber and of the composition of the present disclosure can be calculated and/or determined by a skilled person.

In some embodiments, the edible product is a food product or a beverage product.

In some embodiments, the food product is selected from baked goods, dairy products, frozen desserts, dressing, condiments, spreads, cereal, granola, confections, pasta, grain products, prepared meals, processed fruits, dried fruits, sauces, processed nut products and canned foods.

In some embodiments, the baked goods are selected from cakes, cookies, biscuits, and breads.

In some embodiments, the beverage product is selected from dairy products, liquid meal replacements, soft drinks, instant beverage products, creamers, and juices.

In some embodiments, dairy product is a fermented dairy product, optionally yogurt or kefir.

In some embodiments, the instant beverage products are selected from instant coffee products, instant tea products, and mixtures thereof. In some embodiments, the instant beverage products are liquid products. In some embodiments, the instant beverage products are solid products.

In some embodiments, the edible product is a nutraceutical product. In some embodiments, the nutraceutical product is selected from a protein mix, a vitamin supplement, a fiber supplement, nutrition bar, and meal replacement.

In some embodiments, the packaging is selected from a packet, a bottle, a bag, a box and a tub.

In another aspect, the present disclosure includes a sweetener composition comprising a mixture of modified saccharide products obtained by a reaction process involving:
(i) thermal hydrolysis of a saccharide having a degree of polymerization (DP) greater than 3 to form one or more depolymerization products; and
(ii) coupling of the one or more depolymerization products, which comprise one or more hydrolyzed polysaccharides, oligosaccharides with DP greater than 2, or monosaccharides, in the presence of one or more organic compounds or a derivative thereof, to form one or more coupling products, wherein the organic compound, or derivative thereof, has a sweetness level equal to or greater than sucrose; and
(iii) repolymerization of the coupling products to form an oligosaccharide coupled organic compound, a polysaccharide coupled organic compound, a hydrolyzed polysaccharide coupled organic compound or a monosaccharide coupled organic compound.

In another aspect, the present disclosure includes a consumable product comprising the sweetener composition of the present disclosure.

In another aspect, the present disclosure includes a food product, beverage product, nutritional supplement product, or a pharmaceutical formula product comprising the sweetener composition of the present disclosure.

In another aspect, the present disclosure includes a prebiotic comprising the sweetener composition of the present disclosure.

In some embodiments, the reaction is carried out as a continuous process or a batch process, and the batch process is a multi-batch or a one-pot process.

In some embodiments, the saccharide is a linear, branched or crosslinked saccharide.

In some embodiments, said sweetener composition has a sweetness property similar to sucrose. In some embodiments, the sweetener composition is a low intensity sweetener and having a lower sweetness level than the sweetness level of the organic compound, or derivative thereof, from which it is made. In some embodiments, the sweetener composition has a sweetness level similar to sucrose.

In some embodiments, the coupling and/or repolymerization steps form linear and/or branched saccharide chains.

In some embodiments, the organic compound, or derivative thereof, is selected from one or more of the following: steviol glycoside, sucralose, aspartame, Siraitia grosvenori extract, Glycyrrhiza uralensis Fischer extract, thaumatin, and agave syrup, a modified monosaccharide, a modified disaccharide, and derivatives thereof.

In some embodiments, the saccharide is a polysaccharide, the polysaccharide is fiber (fibre), starch, or derivative thereof, and the fiber is soluble and/or insoluble fiber.

In some embodiments, the sweetener composition is for use in a consumable product.

In some embodiments, the sweetener composition is for use in a food product, a beverage product, a nutritional supplement product, or a pharmaceutical formula product.

In some embodiments, the sweetener composition is for use as a prebiotic, a low calorie sweetener, a reduced calorie sweetener or a sugar substitute.

### II. Methods and Uses of the Disclosure

In another aspect, the present disclosure includes a method of preparing a sweetened fiber,
wherein the sweetened fiber comprises a sweetener attached to at least one molecule of fiber, wherein each of the at least one molecule of fiber is attached to the sweetener through an oxygen atom of the sweetener via a glycosidic bond, and wherein the at least one molecule of fiber comprises a trisubstituted saccharide monomer,
wherein the method comprises:
   combining the fiber and the sweetener to obtain a fiber mixture,
   combining the fiber mixture with an acid to obtain a fiber paste, and heating the fiber paste to obtain a heated fiber paste, the heated fiber paste comprising the sweetened fiber.

In some embodiments, the method further comprises combining the heated fiber paste with water to obtain a second fiber mixture.

In some embodiments, the method further comprises heating the second fiber mixture.

In some embodiments, the fiber is obtained from dextrinization of starch.

In some embodiments, the method further comprises, prior to the combining of the sweetener and the fiber, dextrinizing a starch to obtain the fiber, optionally the dextrinizing of the starch comprises heating the starch in the presence of a second acid.

In some embodiments, the acid comprises a protic acid, optionally the protic acid is selected from citric acid, HCl, acetic acid, sulfuric acid, phosphoric acid, nitric acid, formic acid, tartaric acid, malic acid, lactic acid, oxalic acid, succinic acid, benzoic acid, propionic acid, butyric acid, glycolic acid, maleic acid, fumaric acid, malonic acid, acrylic acid, and combinations thereof, optionally the protic acid is citric acid, HCl, or acetic acid.

In some embodiments, the acid comprises a Lewis acid. For example, the Lewis acid is boric acid.

In some embodiments, the acid is in the form of an aqueous solution.

In some embodiments, the aqueous acid solution comprises the acid at a concentration of about 0.02% w/v to about 4% w/v, about 0.04% v/v to about 3% w/v, about 0.04% w/v to about 2% v/v, about 0.04% w/v, about 0.5% w/v, about 1% w/v or about 2% w/v.

In some embodiments, the acid is combined with the fiber mixture in combination with water.

In some embodiments, the acid is combined with the fiber mixture substantially in the absence of water.

In some embodiments, the sweetener is combined with the fiber at about 0.5% w/w to about 5% w/w, about 1% w/w to about 4% w/w, about 1.5% w/w to about 3% w/w, or about 2% w/w based on the weight of the fiber, optionally the sweetener is a natural sweetener.

In some embodiments, the sweetener is combined with the fiber at about 0.01% w/w to about 0.5% w/w, about 0.01% w/w to about 0.4% w/w, about 0.02% w/w to about 0.2% w/w, about 0.05% w/w to about 0.15% w/w, or about 0.1% w/w based on the weight of the fiber. In some embodiments, the sweetener is an artificial sweetener.

It may be that the sweetener is substantially completely reacted and that any unreacted sweetener is substantially removed by purification. As such, in some embodiments, the sweetened fiber of the present disclosure is substantially free of unreacted sweetener.

In some embodiments, the heating of the fiber paste is carried out at about 50° C. to about 170° C., about 50° C. to about 155° C., about 55° C. to about 65° C., about 60° C. to about 70° C., about 100° C. to about 140° C., about 130° C. to about 155° C., about 140° C. to about 155° C., or about 150° C.

In some embodiments, the heating of the fiber paste is carried out for about 3 hours to about 12 hours, about 4 hours to about 7 hours, or about 4 hours to about 6 hours.

In some embodiments, the method further comprises cooling the heated fiber paste prior to the combining of the heated fiber paste with the water.

In some embodiments, the heating of the second fiber mixture is carried out at about 50° C. to about 170° C., about 50° C. to about 155° C., about 55° C. to about 65° C., about 60° C. to about 70° C., about 100° C. to about 140° C., about 130° C. to about 155° C., about 140° C. to about 155° C., or about 150° C.

In some embodiments, the heating of the second fiber mixture is carried out for about 1 hour to about 6 hours, about 1.5 hour to about 5 hours, or about 2 hours to about 5 hours.

In some embodiments, the method further comprises purifying the sweetened fiber. For example, the sweetened fiber is purified by ion exchange resin.

In another aspect, the present disclosure includes a use of the sweetened fiber or the compositions of the present disclosure in the preparation of an edible product.

In another aspect, the present disclosure includes a use of the sweetened fiber or composition of the present disclosure for replacing sugar in the preparation of an edible product.

In another aspect, the present disclosure includes the sweetened fiber or composition of the present disclosure for use in the preparation of an edible product.

In another aspect, the present disclosure includes the sweetened fiber or composition of the present disclosure for use in the replacement of sugar.

It can be appreciated that the methods of the present disclosure may comprise heating the sweetener in the presence of the fiber. Accordingly, sweeteners suitable for the methods of the present disclosure can withstand heating at the desired temperature. It is understood that the saccharide monomers in the fiber may start to degrade at certain elevated temperatures. Therefore, the heating can be carried out at a temperature below the temperature at which the fiber starts to degrade. Therefore, depending on the nature of the fibers and the saccharide monomers in the fibers, the sweetener can be chosen according to the temperature of heating. For example, glucose is known to degrade at above about 160° C. Accordingly, when a fiber comprising glucose is used in the methods of the present disclosure, the heating step should be carried out at a temperature below about 160° C. For instance, the heating step can be carried out at about 150° C. Therefore, sweeteners that are suitable for use in such methods should also be able to withstand heating to about 150° C. For instance, in the case of fibers comprising fructose, the fructose monomers would start to degrade at above about 70° C. Therefore, the heating step can be carried out at a temperature below about 70° C., for example at 60° C. In this case, sweeteners that may be used should be stable at a temperature of below about 70° C., for example, at about 60° C.

Nevertheless, it is also contemplated that the heating step is not required to be carried out at temperatures that are so elevated or close to the maximum tolerated temperature of the carbohydrate. For instance, with glucose comprising fibers, although glucose can withstand up to 160° C. of temperature, the heating step can also occur at about 50° C., about 60° C., about 70° C., about 80° C., about 90° C., about 100° C., about 120° C., or about 140° C. In each case, the sweeteners selected only need to be thermally stable to the temperature used in the heating step. It can be appreciated that such a selection can be made by a skilled person.

In some embodiments, the sweetener is heat stable at a temperature of about 70° C. to about 160° C., about 70° C. to about 150° C., or about 100° C. to about 150° C.

In some embodiments, the methods of preparing a sweetened fiber of the present disclosure further comprises purifying the sweetened fiber. In some embodiments, the purifying comprises resin purification, chromatography, filtration, concentration, decolorization, sterilization, or combinations thereof. In some embodiments, the purifying is carried out by ion exchange chromatography.

In some embodiments, the methods of preparing a sweetened fiber of the present disclosure further comprises drying the sweetened fiber. For example, the drying comprises spray drying.

In some embodiments, the methods of preparing a sweetened fiber of the present disclosure further comprises packaging the sweetened fiber.

In another aspect, the present disclosure includes a use of the sweetened fiber of the present disclosure as a general-purpose sweetener. For example, the sweetened fiber of the present disclosure can be for use as a general-purpose nutritive sweetener. In some embodiments, the sweetened fiber of the present disclosure is for use as a table-top sweetener.

For example, the sweetened fiber of the present disclosure can be used as replacement or substitute for other sweeteners, especially those sweeteners used in the food industry. For example, the sweetened fiber of the present disclosure can be used as a partial or full replacement for other nutritive sweeteners such as sucrose, corn syrup, high-fructose corn syrup and polyols. The sweetened fiber of the present disclosure can also be used as partial or full replacement for high-intensity sweeteners.

Since the sweetened fiber of the present disclosure comprises fiber, in another aspect, the present disclosure also includes a use of the sweetened fiber of the present disclosure as a fiber ingredient, for example, in food preparation, in pharmaceutical preparations, or as a nutritional supplement. In some embodiments, the sweetened fiber of the present disclosure is used in combination with other fiber ingredients.

For some edible products, 100% of added sugars may be replaced with the sweetened fiber of the present disclosure. For other products, a much smaller substitution may be used. Furthermore, manufacturers' variation in the sweetened fiber usage to produce healthy, palatable products can be coupled with consumers' self-regulation of consumption of these products, based upon individual preferences.

In another aspect, the present disclosure includes a use of the sweetener composition of the present disclosure as a sugar substitute.

In another aspect, the present disclosure includes a process for preparation of a sweetener composition having a mixture of modified saccharide products, the process comprising the steps of:
(i) thermal hydrolysis of a saccharide having a degree of polymerization (DP) greater than 3 to form one or more depolymerization products;
(ii) coupling of the one or more depolymerization products, which comprise one or more hydrolyzed polysaccharides, oligosaccharides with DP greater than 2, or monosaccharides, with one or more organic compounds or a derivative thereof, to form one or more coupling products, wherein the organic compound, or derivative thereof, has a sweetness level equal to or greater than sucrose; and
(iii) repolymerization of the coupling products to form an oligosaccharide coupled organic compound, a polysaccharide coupled organic compound, a hydrolyzed polysaccharide coupled organic compound or monosaccharide coupled organic compound.

In some embodiments, the saccharide is a linear, branched or cross-linked saccharide, or the repolymerization forms linear or branched saccharide chains.

In some embodiments, the reaction is carried out as a continuous process or a batch process, and the batch process is a multi-batch or a one-pot process.

In some embodiments, said sweetener composition has a sweetness property similar to sucrose.

In some embodiments, the sweetener composition is a low intensity sweetener and having a lower sweetness level than the sweetness level of the organic compound, or derivative thereof, from which it is made. In some embodiments, the sweetener composition has a sweetness level similar to sucrose.

In some embodiments, the coupling and/or repolymerization steps form linear and/or branched saccharide chains.

In some embodiments, the reaction is carried out in an acidic medium at elevated temperature.

In some embodiments, the organic compound, or derivative thereof, is selected from one or more of the following: steviol glycoside, sucralose, aspartame, Siraitia grosvenori extract, Glycyrrhiza uralensis Fischer extract, thaumatin, and agave syrup, a modified monosaccharide, a modified disaccharide, or derivatives thereof.

In some embodiments, the saccharide is a polysaccharide. In some embodiments, the polysaccharide is fiber (fibre), starch, or derivative thereof, and wherein the fiber is soluble and/or insoluble fiber. In some embodiments, the polysaccharide comprises insoluble and/or soluble fiber (fibre). In some embodiments, the insoluble fibre is selected from the group consisting of dietary fibre, cereal bran, oat fibre, bamboo fibre, fruit fibres, sugar beet fibre, sugar cane fibre, tomato fibre, coconut fibre, straw from cereals such as wheat or barley, pea fibre, tea, coffee, potato fibre, cocoa, cocoa powder, bran waste, sugar waste, cocoa waste, corn-cob waste, cellulose, hemi-cellulose, chitosan, pectins, gums, mucilages, lignins, compositions comprising the same or combinations thereof. In some embodiments, the soluble fibre is selected from the group consisting of resistant dextrin, resistant/modified maltodextrin, polydextrose, b-glucan, galactomannan, fructo-oligosaccharides, gluco-oligosaccharide, galacto-oligosaccharides, MOS (mannose-oligosaccharides), pectin, psyllium, inulin, resistant starch, compositions comprising the same or combinations thereof.

### EXAMPLES

The following non-limiting examples are illustrative of the present disclosure.

### Example 1 Preparation of Sweetened Fiber

### 1-1 Corn Sweetened Fiber Procedure:

Corn Fiber and Rebaudioside M (2% w/w, with respect to Fiber) were mixed well. A solution of 2.0% aq. Citric acid (0.10 v/w) and distilled water (0.08 v/w) added to the above fiber mixture and mixed. The wet paste placed in hot air oven at 150° C. for 4-6 hours. Cooled to room temperature (˜25° C.) and crushed. Distilled water (0.2 v/w) added to the reaction mass, mixed and placed in oven at 150° C. for 4-5 hours. Cooled to room temperature (˜25° C.) and crushed. The resulting product was purified by ion exchange resin such as Purolite A860™.

### 1-2 Tapioca Sweetened Fiber Procedure:

Tapioca Fiber and Rebaudioside M (2% w/w, with respect to Fiber) were mixed well. A solution of 2.0% aq. Citric acid (0.10 v/w) and distilled water (0.08 v/w) added to the above fiber mixture and mixed. The wet paste placed in hot air oven at 150° C. for 4-6 hours. Cooled to room temperature (˜25° C.) and crushed. Distilled water (0.2 v/w) added to the reaction mass, mixed and placed in oven at 150° C. for 3-5 hours. Cooled to room temperature (˜25° C.) and crushed. The resulting product was purified by ion exchange resin.

### 1-3 Tapioca Sweetened Fiber Procedure:

Tapioca Fiber and Rebaudioside M (2% w/w with respect to Fiber) were mixed well. A solution of 0.04% aq. Hydrochloric acid (0.06 v/w) and distilled water (0.1 v/w) added to the above fiber mixture and mixed. The wet paste was placed in hot air oven at 150° C. for 4-6 hours. Cooled to room temperature (˜25° C.) and crushed. The resulting product, purified by resin.

### 1-4 Tapioca Sweetened Fiber Procedure:

Tapioca Fiber and Rebaudioside M (2% w/w with respect to Fiber) were mixed well. A solution of 1.0% aq. solution of Citric acid (0.1 v/w) and 0.01% aq. Hydrochloric acid (0.06 v/w) and distilled water (0.02 v/w) were added to the above fiber mixture and mixed. The wet paste was placed in hot air oven at 150° C. for 4-6 hours. Cooled to room temperature (˜25° C.) and crushed to obtain the product. To the product added 0.2 v/w of water, mixed and placed in oven at 150° C. for 4-6 hours. Cooled to room temperature (˜25° C.) and crushed to obtain the product. Further, 0.26 v/w water added to 15 g of product, mixed, and placed in oven at 150° C. for 2-4 hours. Cooled to room temperature (˜25° C.) and crushed to obtain the product. Finally, the product was purified by ion exchange resin to obtain the purified product.

### 1-5 Corn Sweetened Fiber Procedure:

Corn Fiber and Rebaudioside M (2% w/w with respect to Fiber) were mixed well. A solution of 2.0% aq. Citric acid (0.10 v/w) and 0.01% aq. Hydrochloric acid (0.06 v/w) added to the above fiber mixture and mixed. Additional distilled water (0.02 v/w) was added to the above fiber mixture and mixed. The wet paste was placed in hot air oven at 150° C. for 4-6 hours. Cooled to room temperature (˜25° C.) and crushed to obtain the product. To the product, added distilled water (˜0.2 v/w), mixed and placed in oven at 150° C. for 3-5 hours. Cooled to room temperature (˜25° C.) and crushed to obtain the product. The product was finally purified by ion-exchange resins.

### 1-6 Corn High Sweetened Fiber Procedure:

Corn Fiber, Rebaudioside M (194.4% w/w with respect to Fiber) and glucose (38.8% w/w) were mixed well and sprayed with acetic acid (111% v/w). The sample was mixed well and then placed in oven at 150° C. for 3-5. The product was cooled to room temperature (˜25° C.), milled to a powder, and purified by ion exchange resins.

### Example 2 Characterization of the Sweetened Fiber

The sweetened fibers prepared in Example 1 were characterized by a number of analytical methods to determine the MW, Mn, and DP of the sweetened fiber, and the nature of the glycosidic bonds present in the fiber.

### 2-1 MW/Mn, Polydispersity Index (PDI), and DP

The MW, Mn, and PDI of the sweetened fibers were determined using size exclusion chromatography (SEC)/gel permeation chromatography (GPC) (Viscotek™ TDA305 and GPCmax™; refractive index and light scattering detectors; mobile phase=0.1 M NaNO₃ in water; SEC/GPC columns=PAA-202+PAA-203; 30° C., analysis software=OmniSEC™ 4.6.2).

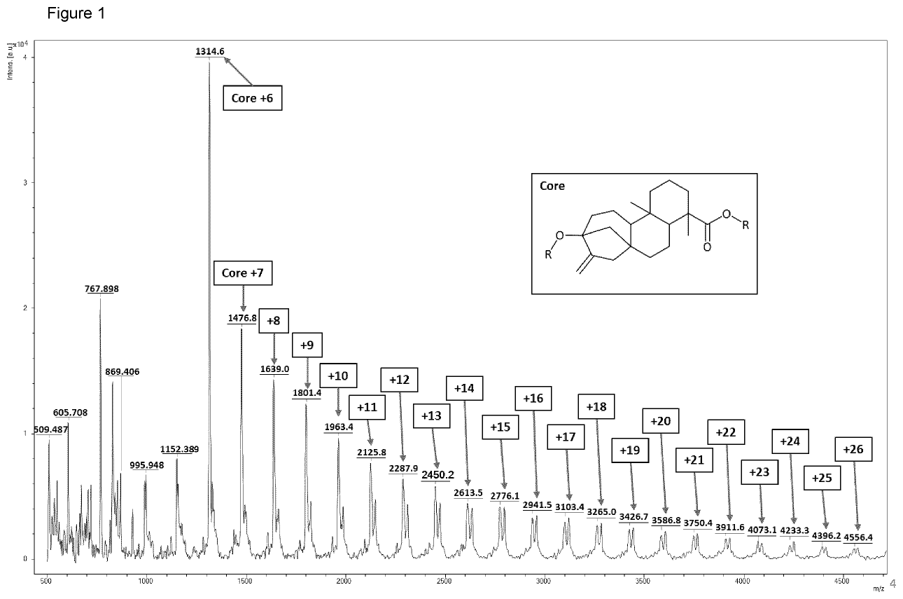

The DP of the sweetened fiber was determined using MALDI. An exemplary MALDI spectrum of a corn sweetened fiber of the present disclosure is shown in FIG. 1.

The results are presented in Table 1.

TABLE 1
Characterization of Sweetened Fibers

| | Mn | Mw | Mz | Mw/Mn | Avg. |
|---|---|---|---|---|---|
| Sample | (Da) | (Da) | (Da) | (PDI) | DP |
| Tapioca Fiber | 768 | 1732 | 3036 | 2.26 | 10.57 |
| Tapioca sweetened fiber | 3487 | 4639 | 6704 | 1.33 | 28.50 |
| Corn fiber | 1444 | 2587 | 6286 | 1.791 | 15.84 |
| Corn sweetened fiber | 3041 | 4375 | 7552 | 1.438 | 26.87 |

$Avg . DP = \frac{Avg . Mw - 18.02 Da}{162.14 Da}$

As shown by Mw and Mn, the sweetened fiber is larger in size than the respective starting material fiber. PDI values show tighter molecular weight distribution (smaller PDI in the sweetened fiber compared to starting material). As such, a shift in distribution toward larger fibers was observed.

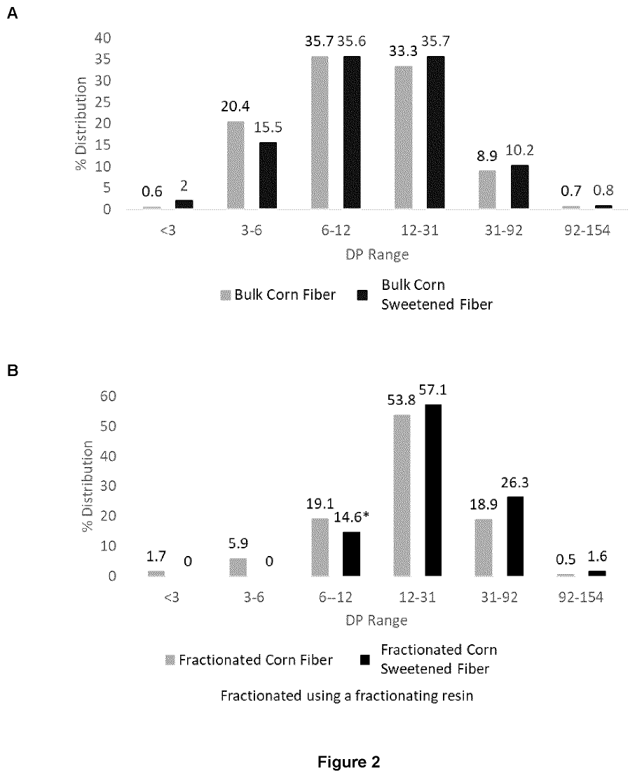

The distribution of fiber size in terms of DP is shown in the histograms of FIG. 2. As shown, the sweetened fiber exhibited notable change in % distribution of polymer size in both bulk material (FIG. 2 Panel A) and fractionated material (FIG. 2 Panel B). There is a decrease in fiber with lower DP (e.g. 3-6 and 6-12) and an increase in fiber with higher DP (e.g. 12-31, 31-92, and 92-154)

### Characterization of Glycosidic Linkages in Fibers

The substitution pattern and types of glycosidic linkages in the sweetened fibers of the present disclosure were determined using known methods. The sweetened fibers and starting material fibers were converted to partially O-methylated alditol acetylates using methyl iodide and NaOH. The reaction can be repeated to ensure a complete methylation. Afterward, the samples were hydrolyzed with trifluoroacetic acid (TFA), with subsequent evaporation of the acid. For the carbonyl reduction, NH3 and sodium borodeuteride were used. The partially methylated alditols were acetylated by adding 1-methylimidazole and acetic anhydride. The partially O-methylated alditol acetates (PMAA) were extracted with dichloromethane. Then, the dichloromethane was evaporated, and the samples were dissolved in anhydrous acetone, which was evaporated prior the GC-MS analysis.

The PMAAs obtained were analyzed by gas chromatography mass spectrometry (GC-MS).

α, β anomer content was assessed using H-NMR.

The results are presented in Table 2.

TABLE 2
Substitution pattern of the Sweetened Fiber

| | | | Tapioca Sweetened | | |
|---|---|---|---|---|---|
| | Tapioca Fiber | | fiber | | Sweetened fiber |
| Substitution | % | Error | % | Error | vs Tapioca Fiber |
| Type | monomers | (±) | monomers | (±) | Difference |
| Terminal Glc | 52.3 | 0.2 | 36.2 | 2.5 | −16.1 |
| 1,3-Glc | 7.3 | 0.2 | 6.9 | 0.2 | −0.4 |
| 1,2-Glc | 4.2 | 0.1 | 5 | 0.2 | 0.8 |
| 1,6-Glc | 18.4 | 0.2 | 22.8 | 0.9 | 4.4 |
| 1,4-Glc | 12.6 | 0 | 13.2 | 0.4 | 0.6 |
| 1,3,4-Glc | 1 | 0.1 | 0.8 | 0.4 | −0.2 |
| 1,2,3-Glc | 0.3 | 0 | 1.5 | 0.1 | 1.2 |
| 1,2,4-Glc | 0.6 | 0 | 1.5 | 0.1 | 0.9 |
| 1,3,6-Glc | 1.1 | 0.1 | 3.7 | 0.6 | 2.6 |
| 1,4,6-Glc | 2.1 | 0 | 6.1 | 0.3 | 4 |
| 1,2,6-Glc | | | 2.4 | 0.2 | 2.4 |
| % α-Glc | 67.7 | | 65 | 0.1 | −2.7 |
| % β-Glc | 32.3 | | 34.9 | 0.1 | 2.6 |

As shown, there is a significant decrease in terminal glucose and an increase in trisubstituted and non-linear (non-1,4 linkages) substitutions. A 500% increase in 1,2,3-trisubstituted monomers, 250% increase in 1,2,4-trisubstituted monomers, 340% increase in 1,3,6-trisubstituted monomers, and/or 300% 1,4,6-trisubstituted monomers were observed in the exemplary sweetened fiber relative to the starting material fiber. This indicates that the sweetened fiber has more branching and, thus, more steric bulk than linear fibers. The increase in β-glycosidic bonds also suggests a lower digestibility for humans.

### Example 3 Solubility Testing of Sweetened Fiber

Solubility of a corn sweetened fiber of the present disclosure prepared according to Example 1 was determined. 100 mL of distilled water was measured in a clean beaker. Small portions of the sweetened fiber were added with stirring at room temperature until the sweetened fiber no longer dissolves. Sucrose was also measured in a separate beaker as a comparison.

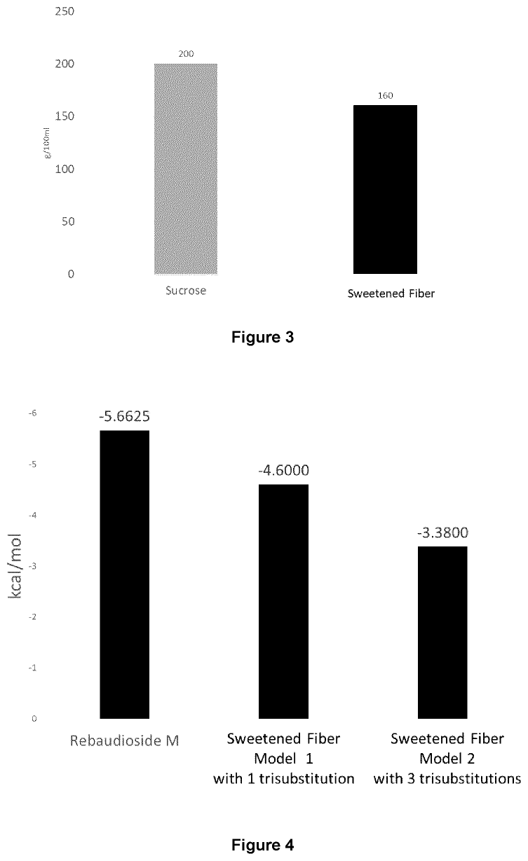

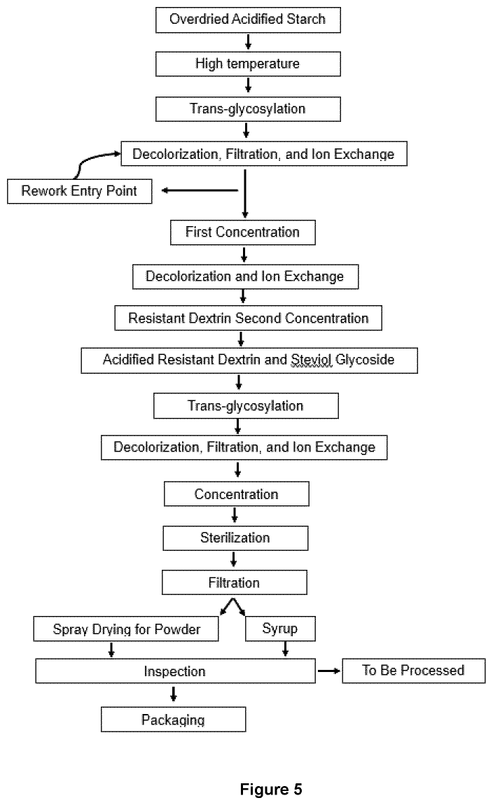

The results are shown in FIG. 3. As seen, the sweetened fiber of the present disclosure has a high solubility that is comparable to that of sucrose.

### Example 4 Sensory Testing of Sweetened Fiber

The taste of the sweetened fiber of the present disclosure prepared according to Example 1 was assessed by an external third party using a panel of tasters. A group of twelve panelists formed a panel for the sensory evaluation. The ranking test was used to measure the overall difference and intensity score for four sensory attributes, flavor, aftertaste, and mouthfeel. Each panelist evaluated all four samples. The data from the ranking test showed no statistically significant difference among the four samples at a level of 5% significance. The results also showed that at a 5% significance level, there were no statistically significant differences in terms of seven attributes (Sweetness, Strength of flavor, Bitterness, Licorice taste, Sweet aftertaste, Off flavor, Mouthfeel) among the four samples.

Sample Preparation: Two 250 mL samples were prepared (10% solutions of sucrose (control) and corn sweetened fiber of Example 1-1. A sensory code consisting of a random 3-digit number was assigned to each sample.

Taste Session: The sensory evaluation was carried out at BioFoodTech's Sensory Lab. Twelve experienced panelists were divided into two groups. A complete block design was chosen for the sensory evaluation of the four samples, including a ranking test used to determine the overall difference.

Statistical Analysis for the Data: For the individual attributes, Analysis of Variance (ANOVA) and the Tukey-Kramer HSD test were used to analyze the difference among sample means of individual attributes at a 5% significance level. For the Ranking test, a Friedman-type statistic was used to determine if there was a statistically significant difference among samples at a 5% significance level. All statistical analyses were done using the JMP®8 (SAS Institute Inc., Cary, NC).

The results are shown in Tables 3 and 4.

TABLE 3
Result of Individual Attributes of Taste Session (n = 12)

| | | Corn |
|---|---|---|
| | | Sweetened |
| | | Fiber (Example |
| | 10% sugar | 1-1) |
| Sweetness | 100% | 100% |
| Taste preference | 98% | 100% |
| Mouthfeel | 73% | 73% |
| Off-flavour | 0% | 1% |

TABLE 4
Results of Ranking Taste Preference

| | | 10% solution |
|---|---|---|
| | | of Corn |
| | | sweetened |
| | 10% solution of | fiber (Example |
| | sucrose | 1-1) |
| Rank mean | 2.58 | 1.83 |
| RankSum | 31 | 22 |

| | |
|---|---|
| Friedman | 5.1 |
| LSDrank | 12.39 |
| p value | 0.165 |

Based on the sensory evaluation and statistical analysis results, it was observed that at a 5% significance level, there was no significant difference of overall quality among the two samples. Further, at a 5% significance level, there were no significant differences in terms of seven attributes (Sweetness, Strength of flavor, Bitterness, Licorice taste, Sweet aftertaste, Off flavor, Mouthfeel) among the samples.

### Example 5 Formulation of Sweetened Fiber in Edible Products

To test the usability of the sweetened fiber of the present disclosure in various food recipes, a number of edible products were made and tasted.

### Hot Chocolate Sachet

The recipe used is shown in Table 5. Each ingredient was weighed and added to powder mixer. The ingredients were mixed thoroughly and placed in a sachet packaging.

To make the hot chocolate, the sachet was emptied into a container, and hot water was added with stirring to the desired consistency.

TABLE 5
Hot Chocolate Sachet Recipe

| Ingredient | Quantity |
|---|---|
| Corn Sweetened Fiber of | 21.28 g |
| Example 1 | |
| Natural cocoa powder 10-12% fat | 1.1 g |
| content | |
| Cocoa Powder Alkalized 20-22% | 2.2 g |
| FAT | |
| Caramel Flavor | 0.005 g |
| Sea Salt | 0.120 g |
| Guar Gum | 0.170 g |
| Total | 25.0 |

### Dark Chocolate

The recipe used is shown in Table 6. The ingredients were weighed out individually. The cocoa butter was melted with cocoa liquor and poured into a chocolate grinder. All the ingredients were added to a refining machine to be refined. The resulting chocolate mixture was poured into a tempering machine to be tempered. The chocolate was then moulded, any air bubbles removed and chilled inside a chiller. The chilled chocolate was removed from the moulds and packaged.

TABLE 6
Dark Chocolate Recipe

| | |
|---|---|
| Tapioca Sweetened | 1947 |
| Fiber of Example 1 | |
| Cocoa Liquor | 1120 |
| Cocoa Butter | 920 |
| Vanilla beans | 8.0 |
| Caramel Flavour | 0.42 |
| Sea Salt | 4.0 |
| Total | 4000.0 |

### Coffee Sweetener

Corn or tapioca sweetened fiber was added directly to coffee and mixed until the desired level of sweetness was achieved. The fiber was completely soluble, and the taste was similar to that coffee sweetened with sucrose.

### Chocolate Spread

The recipe used is shown in Table 6. All ingredients were weighed and placed in a chocolate refining machine to be refined. The mixture was refined until desired particle size was about 30 microns. The resulting spread was then packaged.

TABLE 7
Chocolate Spread Recipe

| | | |
|---|---|---|
| Tapioca Sweetened Fiber | 145 | g |
| Hazelnut Butter | 147 | g |
| Cocoa powder | 24 | g |
| Vanilla Extract | 2.1 | ml |
| Sea Salt | 0.75 | g |
| Caramel flavor | 0.03 | g |
| Vanilla Flavor | 3.00 | g |

| | |
|---|---|
| Total | 322 |

### Example 5 Binding Affinity of Sweetened Fiber on Sweetness Taste Receptor

### Template Selection

Natural and artificial sweeteners are known to activate the sweet taste receptor. This taste receptor is a heterodimer belonging to the class C family of G-protein coupled receptors (GPCRs) and is composed of the hT1R2 and hT1R3 subunit.

The metabotropic glutamate receptor 3 or mGluR3 belongs to the class C family of GPCRs. mGluR3 shares sequence identity with both hT1R2 and hT1R3. Therefore, mGluR3 has been used in the literature as a template to model sweet taste receptors hT1R2 and hT1R3 (Waldo Acevedo, César A. Ramirez-Sarmiento, Eduardo Agosin, Identifying the interactions between natural, non-caloric sweeteners and the human sweet receptor by molecular docking, Food Chemistry, Volume 264, 2018, Pages 164-171, ISSN 0308-8146, incorporated herein by reference.)

### Sweet Taste Receptor Preparation for Docking

The crystal structure 2E4U of mGluR3 was downloaded from the RCSB Protein Data Bank. The three-dimensional structure of Rebaudioside M ligand was obtained from the PubChem database in SDF file format from PubChem. A two-dimensional model of the sweetened fiber was built using the experimental glycosidic bond characterization. The three-dimensional structure of the model was built using Avogadro (https://www.kitware.com/avogadro-2-and-open-chemistry/) to use as a ligand for docking onto the crystal structure of mGluR3.

The receptor and ligands were processed using MGLtools (Di Muzio, E., Toti, D. & Polticelli, F. DockingApp: a user-friendly interface for facilitated docking simulations with AutoDock Vina. J Comput Aided Mol Des 31, 213-218 (2017), incorporated herein by reference, and saved as pdbqt for docking simulations using Autodock Vina (O. Trott, A. J. Olson, AutoDock Vina: improving the speed and accuracy of docking with a new scoring function, efficient optimization, and multithreading, Journal of Computational Chemistry 31 (2010) 455-461 DOI 10.1002/jcc.21334, incorporated herein by reference). Autodock Vina was configured to run up to eight modes and exhaustiveness of 32.

### Results

FIG. 4 shows the calculated binding affinity of Rebaudioside M and two simplified sweetened fiber structures comprising Rebaudioside M. The simplified sweetened fiber 1 comprises one trisubstituted glucose unit (1,2,4), while sweetened fiber 2 comprises 3 trisubstituted glucose units (1,2,4|1,3,6|1,4,6). Rebaudioside M showed an average binding affinity of −5.6625 kcal/mol, while sweetened fiber with one and three tri-substitutions showed −4.60 kcal/mol and −3.38 kcal/mol respectively. The more negative the binding energy, the stronger the binding affinity between the ligand and the protein. Therefore, a lower binding energy values of Rebaudioside M suggests that it can tightly bind to the sweet taste receptor's active site and is less likely to dissociate. Without wishing to be bound by theory, this could explain some of Rebaudioside M's undesirable taste qualities. On the other hand, the sweetened fiber had less negative values and affinity for the sweet taste receptor and it is more likely to dissociate from the sweet taste receptor's active site. This effect was more pronounced when the sweetened fiber had three tri-substitutions, suggesting that the increased branching (e.g. trisubstituted saccharide monomers) produces enough steric hindrance to reduce the binding affinity to the receptor and trigger enough sweetness. As shown above in Example 2, the sweetened fiber of the present disclosure comprises increased trisubstituted saccharide monomers, thus contributing to the increased steric hindrance. Without wishing to be bound by theory, this increased steric hindrance suggests lower binding affinity to the sweet taste receptor, thus attenuating the binding time of the sweetened fiber to the receptor compared to the sweetener itself.

### Example 6 Preparation of Dextrin from Potato Starch with Rebaudioside M

Potato starch was sprayed with a hydrochloric acid solution and citric acid solution. To obtain a final organic acid concentration of 0.01% to 10%. The sample was mixed well for about 5 min to 30 min by a mixer. The sweet organic compound was added to this mixture 0.1% to 10% w/w, mixed well and heated to between 130° C. and 180° C. for 1 h to 15 h. Alternatively, the reaction could be performed under pressured conditions (>1 atm) or at lower temperatures under vacuum (<1 atm). The product was cooled to room temperature and milled to a powder. The powdered dextrin was washed with 90%-95% ethanol to remove excess of unreacted material. The pale-yellow powder was dried at room temperature.

### Example 7 Production of Sweeter Composition

### Preparation of Acidified Starch:

Potato starch sprayed with 0.01% to 10% solution of Hydrochloric acid and 0.01% to 10% solution of citric acid to a final concentration of both acids from 0.01% to 10% the starch weight i.e. The acidified starch was heated at 90° C. to 110° C. for 1 h to 3 h. The acidified and dried starch was then used for the formation of sweetener composition.

Powdered potato starch was added to a mixer, followed by 0.44 wt % HCl (aq, 15%). The mixture was thoroughly blended for 2-30 minutes and then the resulting acidified starch mixture was added to a rotating drum with ventilation to enable adequate air flow and removal of water. The interior of the rotating drum was uneven, with an increased surface area to aid in tumbling and mixing of potato starch during rotation. The uneven surface further prevented the starch mixture from simply sliding along the edge without any tumbling action. The drum containing the acidified starch mixture was slowly rotated and heated at 130° C. to 180° C. for 1 hour to 3 hours with a circulating air flow. A light yellow free-flowing powder was produced, which was readably soluble in water.

Powdered potato starch was microwaved in 30 s increments at 900 W for a total of 10 min (stopping every 30 s to mix the powdered starch before resuming). Microwaved potato starch was added to a mixer, followed by 0.44 wt % HCl (aq, 15%). The mixture was thoroughly blended for 2-30 minutes and then the resulting acidified starch mixture was added to a rotating drum with ventilation to enable adequate airflow and removal of water. The interior of the rotating drum was uneven, with an increased surface area to aid in tumbling and mixing of potato starch during rotation. The uneven surface further prevented the starch mixture from simply sliding along the edge without any tumbling action. The drum containing the acidified starch mixture was slowly rotated and heated at 130° C. to 180° C. for 1 hour to 3 hours with a circulating air flow. A light yellow free-flowing powder was produced, which was readably soluble in water.

Rebaudioside M (0.1% to 10% w/w) and the above-acidified starch were mixed thoroughly and heated at 130° C. to 180° C. for 1 hour to 7 hours. At least 50% of Rebaudioside M reacted. The reaction mixture was triturated with 90%-95% ethanol to remove excess of unreacted material. The slurry was filtered to remove the traces of unreacted material. The wet solid was dried and stored.

### Example 8 Comparative Studies of Sweetened Fiber Vs Mixture of Sweetener and Fiber Vs Free Sucrose

The sensory characteristics of the sweetened fiber of the present disclosure were evaluated against a simple mixture of dietary fiber and stevia extract or stevia extract alone. The preference towards the sweetened fiber of the present disclosure, a mixture of dietary fiber and stevia extract, or stevia extract alone was determined. Any sensory difference between the sweetened fiber of the present disclosure versus a mixture of dietary fiber and stevia extract was evaluated.

### Methods

Study design: randomized crossover. Twelve adults were recruited for the study. Samples were evaluated for pleasantness using 9-point hedonic scales (Peryam, D. R., Girardot, N. F. (1952). Advanced taste test method. Food Engineering, 24, 58-61, 194.). Unstructured scales such as visual analogue scales (VAS) are also used for the sensory evaluation of food (Baten, W. D. (1946). Organoleptic tests pertaining to apples and pears. Journal of Food Science, 11, 84-94.). The intensity of off-taste, bitterness and sweet aftertaste sweetness were determined using a 10-point scale.

Protocol: Participants attended one research session that lasted up to 60 min. Participants were familiarized with the study protocol and research tools used in the study, including vocabulary with food sensory lexicon. They used a pen to rate their subjective perception of hedonic and intensity scales.

After this brief introduction, the blinded and coded food samples containing water with added the sweetened fiber of the present disclosure (10%) or dietary fiber plus Reb M (10%) or Reb M alone (10% equivalent) were provided randomly. The preference test was conducted first, and intensity tests were performed subsequently. All sensory testing was performed using a pen and paper. Once the sensory evaluation of the sample was completed, participants were asked to drink water to clean their palates.

Data analysis: The normality of the data was evaluated using D'Agostino & Pearson omnibus normality test. If the data didn't follow a normal distribution, the statistical significance of preference and intensity was assessed with the Kruskal-Wallis test using an alpha criterion of 5%. A significant difference among the groups (P≤0.05) was followed by Dunn's multiple comparison test to identify the groups with differences. The statistical analysis and the graphs were prepared using GraphPad Prism version 6 for Windows, GraphPad Software, San Diego, CA, U.S.A. The data are presented as the means with their standard error of mean (SEM). The statistical significance was set at P≤0.05.

### Results and Discussion

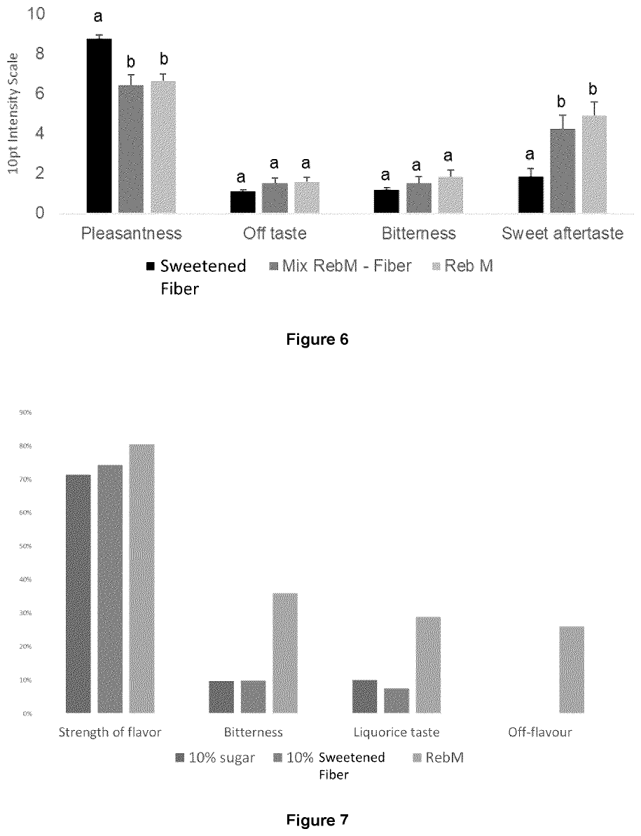

FIG. 6 shows that the pleasantness of the sweetened fiber of the present disclosure was significantly higher than the fiber/sweetener mix and sweetener alone (P≤0.05). Fiber/sweetener mix and sweetener alone showed no differences in their perceived pleasantness (P>0.05).

When comparing perceived bitterness and off-taste, all the samples were perceived similarly and there was no difference in these attributes (P>0.05).

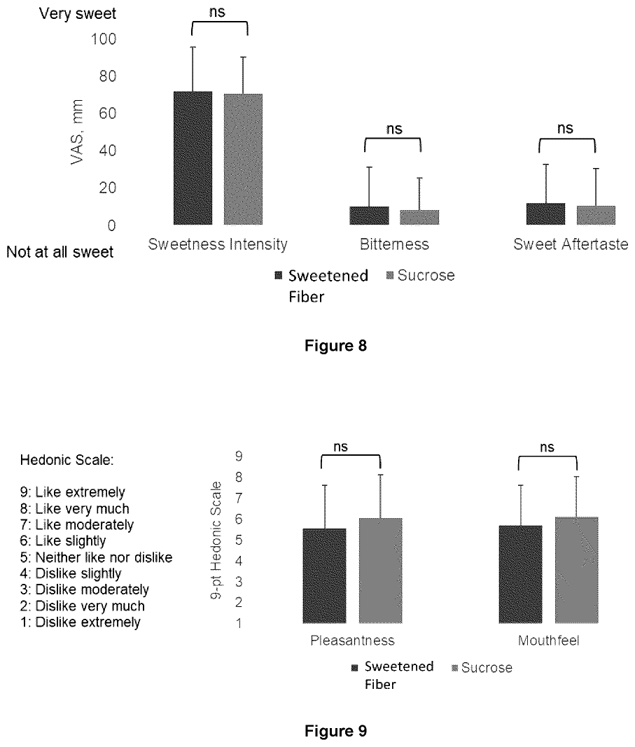

Almost all high-intensity sweeteners (such as Stevia extracts, Monk Fruit, Aspartame, Sucralose, etc. . . . ) almost always exhibit a lingering sweet aftertaste that is different from low-intensity sweeteners (glucose, fructose, sucrose). FIG. 6 shows that the sweetened fiber of the present disclosure had significantly less sweet aftertaste compared to fiber/sweetener mix and sweetener alone (P≤0.05). Furthermore, it is shown herein in Examples 9 and 10 and in FIGS. 8 and 9 that the sweet aftertaste of Sweet Fiber and sucrose was perceived similarly.

The sweetened fibers of the present disclosure have a higher degree of branching due to the presence of trisubstituted saccharide monomers. As such, the high branching nature increases the steric hindrance proximal to the sweetener moiety, which prevents the sweetener moiety from binding the sweetness receptor undesirably tightly. Thus, the sweetened fiber of the present disclosure is expected to dissociate from the sweetness receptor after activating the latter more readily than traditional sweeteners. A faster dissociation would significantly reduce sweet aftertaste compared with the mixture of dietary fiber/Rebaudioside M or a Rebaudioside M-only solution.

### Conclusion

The sweetened fiber of the present disclosure was perceived as significantly more pleasant and less lingering than the mixture of dietary fiber/Rebaudioside M or a Rebaudioside M-only solution.

The sweet taste of the sweetened fiber of the present disclosure is more comparable to natural sugar. Accordingly, the sweetened fiber of the present disclosure has substantially the same lingering time of sweetness as sucrose.

### Example 9 Comparative Studies of Sweetened Fiber Vs Stevia Extract

### Summary

A sensory evaluation session was conducted at BioFoodTech, to determine the taste difference between sucrose, the sweetened fiber of the present disclosure and stevia extract solutions. A group of twelve panelists formed a panel for the sensory evaluation. The ranking test measured the overall difference and intensity score for sensory attributes, including the strength of flavor, bitterness, liquorice taste and off-flavor.

### Methods

A group of experienced panelists from BioFoodTech formed a panel for a sensory evaluation session to determine the quality difference between the sweet product samples.

Three 250 mL samples were prepared (10% solutions of sucrose, 10% the sweetened fiber of the present disclosure and 0.05% solution of Rebaudioside M (RebM). A sensory code consisting of a random 3-digit number was assigned to each sample.

Twelve experienced panelists were divided into two groups. A complete block design was chosen for the sensory evaluation of the two samples, including a ranking test used to determine the overall difference and intensity scoring for four seven attributes (strength of flavor, bitterness, liquorice taste and off-flavor). The four coded samples were presented to each panelist in a balanced order throughout the evaluation.

### Results and Discussion

In the individual attributes evaluation, the panelists were asked to quantify the difference of specific attributes among the four samples by scoring from 1 to 100 (1 for none and 100 for the strongest, see FIG. 7) to reflect the intensity of the attribute best.

FIG. 7 shows the mean score of attributes for the 10% solutions of sucrose, 10% sweet fiber and 0.05% solution of Rebaudioside M (RebM). From the mean scores, the stevia extract scored highest on the strength of flavor, bitterness, liquorice taste and off-flavor. In comparison, the sweetened fiber of the present disclosure scored similarly to sucrose on all the attributes.

Stevia sweeteners, a popular sugar substitute due to their natural origin and zero-calorie nature, often present aftertaste issues. These issues often include a slightly bitter or liquorice-like aftertaste, which some individuals may find unpleasant. The aftertaste can vary depending on the brand, product formulation, and individual taste sensitivity. The sweetened fiber of the present disclosure presented much less aftertaste and undesirable flavors while providing similar strength of flavor compared to sugar and Reb M.

### Example 10 Comparative Studies of Sweetened Fiber Vs Sucrose

The sensory characteristics of an example of the sweetened fiber of the present disclosure were evaluated and compared to those of sucrose. Any preference towards the exemplary sweetened fiber of the present disclosure or sucrose solutions was determined. The sensory acceptance of the exemplary sweetened fiber of the present disclosure and sucrose was evaluated.

### Methods

Study design: double-blinded, randomized crossover. Sixty adults (18-65 years old, 30 males and 30 females) were recruited for the study. Smokers (including e-cigarettes)/cannabis consumers, individuals with food allergies or intolerances, chronic diseases, respiratory diseases, major dental or medical procedures that may affect the perception of taste and smell, and people who take a medicine that influences smell and taste perception were not included in the study. Samples were evaluated for pleasantness, taste, flavour, sweetness, and mouthfeel using 9-point hedonic scales (Peryam, D. R., Girardot, N. F. (1952). Advanced taste test method. Food Engineering, 24, 58-61, 194). Unstructured scales such as visual analogue scales (VAS) are also used for the sensory evaluation of food (Baten, W. D. (1946). Organoleptic tests pertaining to apples and pears. Journal of Food Science, 11, 84-94.). The intensity of sweetness, bitterness, and metallic taste was determined using a 100 mm Visual Analogue Scale (VAS).

Protocol: Participants attended one research session that lasted up to 60 min. A day before the session, participants were reminded not to eat or drink at least one hour before their scheduled session time. Upon their arrival at the laboratory, participants were familiarized with the study protocol and research tools used in the study, including computer tabs, vocabulary with food sensory lexicon, using a stylus pen to rate their subjective perception of hedonic and VAS scales using a sample of water as an example.

Using a “sham sample” helps avoid the first-position effect phenomenon when the first sample is perceived differently than the subsequent samples (Lawless, H., Heymann, H. (2010). Sensory evaluation of food. Springer, New York, NY.). After this brief introduction, the blinded and coded food samples containing water with added exemplary sweetened fiber of the present disclosure (10%) or Sucrose (10%) were provided randomly according to the randomization protocol created with Compusense software. The preference test was conducted first, and acceptance and intensity tests were performed subsequently. All sensory testing was performed using a tab with a stylus pen and administered using Compusense Academic Consortium (Compusense Inc., Guelph, ON, Canada). Once the sensory evaluation of the sample was completed, participants were asked to drink water available in each sensory cubicle to clean their palates.

Data analysis: The preference towards either blinded samples of 10% solution of Sucrose or 10% solution of the exemplary sweetened fiber of the present disclosure was determined with a forced paired preference test (Lawless, H., Heymann, H. (2010). Sensory evaluation of food. Springer, New York, NY.). The statistical significance of preference was assessed with binomial distribution data analysis using an alpha criterion of 5% and the table with minimum values (X) calculated from the z-score approximation to the binomial distribution and required for a significant preference (Lawless, H., Heymann, H. (2010). Sensory evaluation of food. Springer, New York, NY.). The statistical analysis of affective and sensory evaluations was performed using a two-way repeated-measures analysis of variance (RM ANOVA) to detect the effects of treatment and sex and their interaction on perceived acceptance or sensory intensity. If there was an effect of sex (P≤0.05), the data was analyzed separately for males and females. If there was no effect of sex (P>0.05), the pooled data for males and females was analyzed with the Friedman test followed by Dunn's multiple comparisons. The statistical analysis and the graphs were prepared using GraphPad Prism version 9.5.1 for Windows, GraphPad Software, San Diego, CA, U.S.A. The data are presented as the means with their standard deviations (SD). The statistical significance was set at P≤0.05.

### Results

Sixty participants (26.3±8.9 y) completed the study, including 30 males (26.0±8.6 y) and 30 females (26.6±9.0 y).

FIG. 8 shows that the sweetness and bitterness intensity of the exemplary sweetened fiber of the present disclosure was identical to Sucrose at the same concentration of 10%. There were no statistical differences among these attributes (P>0.05). Similarly, there was no difference in perceived metallic taste between the exemplary sweetened fiber of the present disclosure and sucrose solutions (P>0.05).

When comparing the hedonic perception (FIG. 9), there was no difference in perceived pleasantness or mouthfeel between Sucrose-10% and the exemplary sweetened fiber of the present disclosure −10% (P≤0.05).

Other attributes like taste, flavor, aftertaste and overall preference show no differences between and the exemplary sweetened fiber of the present disclosure and Sucrose (P>0.05).

The sensory acceptance of the sweetened fiber of the present disclosure 10% was similar to the acceptance of Sucrose 10%. The mean acceptance values for both the sweetened fiber of the present disclosure and sucrose solutions were neutral or above the neutral on hedonic scales. The sweetness intensity of the exemplary sweetened fiber of the present disclosure was identical to the sweetness intensity of Sucrose. The testing of the exemplary sweetened fiber of the present disclosure did not result in any detected off-tastes. There was no preference towards Sweet Fiber 10% or Sucrose 10% seen with 60 participants.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. A sweetened fiber comprising
a sweetener attached to at least one molecule of fiber,
wherein each of the at least one molecule of fiber is attached to the sweetener through an oxygen atom of the sweetener via a glycosidic bond, and
wherein the at least one molecule of fiber comprises a trisubstituted saccharide monomer, and wherein the trisubstituted saccharide monomer is attached to another saccharide monomer at the C1 position of the trisubstituted saccharide monomer.

2. The sweetened fiber of claim 1, wherein the fiber is selected from resistant/modified maltodextrin, polydextrose, β-glucans, galactomannan, fructo-oligosaccharides, gluco-oligosaccharide, galactooligosaccharides, xylooligosaccharides, mannose-oligosaccharides, pectin, psyllium, inulin and inulin-type fructans, resistant starch, isomaltulose, arabinoxylans, alginates, and combinations thereof.

3. The sweetened fiber of claim 1 or 2, wherein the sweetener is glycosylated.

4. The sweetened fiber of any one of claims 1 to 3, wherein the sweetener is heat stable at a temperature of about 70° C. to about 160° C., about 70° C. to about 150° C., or about 100° C. to about 170° C.

5. The sweetened fiber of any one of claims 1 to 4, wherein the sweetener is a natural sweetener.

6. The sweetened fiber of any one of claims 1 to 5, wherein the sweetener is a diterpene, triterpene or mixture thereof.

7. The sweetened fiber of claim 6, wherein the diterpene is a steviol, and/or steviol glycoside.

8. The sweetened fiber of claim 6, wherein the steviol glycoside is selected from dulcoside A, rebaudioside, steviolmonoside, steviol-19-O-β-D-glucoside, rubusoside, steviolbioside, stevioside, stevioside A, stevioside B, and mixtures thereof.

9. The sweetened fiber of claim 7, wherein the rebaudioside is selected from rebaudioside A, rebaudioside B, rebaudioside G, rebaudioside E, rebaudioside D, rebaudioside I, rebaudioside L, rebaudioside Q2, rebaudioside Q, rebaudioside I2, rebaudioside Q3, rebaudioside I3, rebaudioside M, and mixtures thereof.

10. The sweetened fiber of any one of claims 6 to 10, wherein the triterpene is selected from mogroside V, mogroside IVa, mogroside IVe, aglycyrrhizin and mixtures thereof.

11. The sweetened fiber of any one of claims 1 to 10, wherein the sweetener is rebaudioside M, and/or rebaudioside A.

12. The sweetened fiber of any one of claims 1 to 4, wherein the sweetener is a synthetic sweetener, optionally the synthetic sweetener is selected from advantame, neotame, sucralose, aspartame, and combinations thereof.

13. The sweetened fiber of any one of claims 1 to 12, wherein the sweetener is attached to one or two molecules of fiber.

14. The sweetened fiber of any one of claims 1 to 13, wherein the fiber is maltodextrin, optionally the fiber is resistant dextrin.

15. The sweetened fiber of claim 14, wherein the sweetened fiber has a MW of about 1000 Da to about 7000 Da, about 2000 Da to about 6000 Da, about 3000 Da to about 5000 Da, about 4000 Da to about 5000 Da, about 4000 Da to about 4500 Da, or about 4100 Da to about 4400 Da, or about 4375 DA.

16. The sweetened fiber of claim 14 or 15, wherein the sweetened fiber has a number average molecular weight (Mn) of about 900 Da to about 4500 Da, about 1500 Da to about 4000 Da, about 2000 Da to about 3500 Da, about 2500 Da to about 3500 Da, about 2700 Da to about 3200 Da, about 2900 Da to about 3100 Da, or about 3041 Da.

17. The sweetened fiber of any one of claims 14 to 16, wherein the sweetened fiber has a polydispersity index (PDI) of about 1.25 to about 1.48, about 1.35 to about 1.48, about 1.40 to about 1.45, about 1.42 to about 1.44, or about 1.438.

18. The sweetened fiber of any one of claims 14 to 17, wherein the sweetened fiber has an average degree of polymerization (DP) of about 19 to about 30, about 20 to about 28, about 25 to about 27, about 26 to about 27, or about 26.87.

19. The sweetened fiber of any one of claims 14 to 18, wherein the sweetened fiber has a DP of about 6 to about 154, about 6 to about 92, about 9 to about 99, or about 9 to about 44.

20. The sweetened fiber of any one of claims 14 to 19, wherein each of the at least one molecule of fiber has a DP of about 11 to about 86.

21. The sweetened fiber of any one of claims 14 to 20, wherein the at least molecule of fiber comprises about 32 to 38% terminal glucose based on the total amount of glucose units in the at least one molecule of fiber.

22. The sweetened fiber of any one of claims 14 to 21, wherein the at least one molecule of fiber comprises about 46% to about 50% disubstituted glucose based on the total amount of glucose units in the at least one molecule of fiber.

23. The sweetened fiber of claim 22, wherein the disubstituted glucose is selected from 1,3-disubstituted glucose, 1,2-disubstituted glucose, 1,4-disubstituted glucose, 1,6-disubstituted glucose and combinations thereof.

24. The sweetened fiber of claim 23, wherein the at least one molecule of fiber comprises about 6.7% to about 7.1% of 1,3-disubstituted glucose based on the total amount of glucose units in the at least one molecule of fiber.

25. The sweetened fiber of claim 23 or 24, wherein the at least one molecule of fiber comprises about 4.8% to about 5.2% of 1,2-disubstituted glucose based on the total amount of glucose units in the at least one molecule of fiber.

26. The sweetened fiber of any one of claims 23 to 25, wherein the at least one molecule of fiber comprises about 22.1% to about 23.7% of 1,6-disubstituted glucose based on the total amount of glucose units in the at least one molecule of fiber.

27. The sweetened fiber of any one of claims 21 to 26, wherein the at least one molecule of fiber comprises about 12.8% to about 13.6% of 1,4-disubstituted glucose based on the total amount of glucose units in the at least one molecule of the fiber.

28. The sweetened fiber of any one of claims 14 to 27, wherein the at least one molecule of fiber comprises trisubstituted glucose.

29. The sweetened fiber of claim 28, wherein the trisubstituted glucose is selected from 1,3,4-trisubstituted glucose, 1,2,3-trisubstituted glucose, 1,2,4-trisubstituted glucose, 1,3,6-trisubstituted glucose, 1,4,6-trisubstituted glucose, 1,2,6-trisubstituted glucose, and combinations thereof.

30. The sweetened fiber of any one of claims 14 to 29, wherein the at least one molecule of fiber comprises about 14% to about 17% trisubstituted glucose based on the total amount of glucose units in the at least one molecule of fiber.

31. The sweetened fiber of claim 30, wherein the at least one molecule of fiber comprises about 0.4% to about 1.2% of 1,3,4-trisubstituted glucose based on the total amount of glucose units in the at least one molecule of fiber.

32. The sweetened fiber of claim 30 or 31, wherein the at least one molecule of the fiber comprises about 1.4% to about 1.6% of 1,2,3-trisubstituted glucose based on the total amount of glucose units in the at least one molecule of fiber.

33. The sweetened fiber of any one of claims 30 to 32, wherein the at least one molecule of fiber comprises about 1.4% to about 1.6% of 1,2,4-trisubstituted glucose based on the total amount of glucose units in the at least one molecule of fiber.

34. The sweetened fiber of any one of claims 30 to 33, wherein the at least one molecule of fiber comprises about 3.1% to about 4.3% of 1,3,6-trisubstituted glucose based on the total amount of glucose units in the at least one molecule of fiber.

35. The sweetened fiber of any one of claims 30 to 34, wherein the at least one molecule of fiber comprises about 5.8% to about 6.4% of 1,4,6-trisubstituted glucose based on the total amount of glucose units in the at least one molecule of fiber.

36. The sweetened fiber of any one of claims 30 to 35, wherein the at least one molecule of fiber comprises about 2.2% to about 2.6% of 1,2,6-trisubstituted glucose based on the total amount of glucose units in the at least one molecule of fiber.

37. The sweetened fiber of any one of claims 1 to 36, wherein the sweetened fiber has substantially the same sweetness intensity as sucrose.

38. The sweetened fiber of any one of claims 1 to 36, wherein the sweetened fiber has a sweetness intensity that is about 80% to about 90%, about 85 to about 95%, about 95% to about 100%, about 80%, about 90%, about 95%, or about 100% of that of sucrose.

39. The sweetened fiber of any one of claims 1 to 37, wherein the sweetened fiber has a sweetness intensity that is higher than that of sucrose.

40. The sweetened fiber of claim 39, wherein the sweetness intensity of the sweetened fiber is about 110% to about 300%, or about 150% to about 200% of that of sucrose.

41. The sweetened fiber of any one of claims 1 to 35, wherein the sweetened fiber is water soluble.

42. The sweetened fiber of claim 39, wherein the sweetened fiber has a solubility of about 100 g/100 mL to about 250 g/100 mL, about 120 g/100 mL to about 200 g/100 mL, about 140 g/100 mL to about 180 g/100 mL, or about 160 g/100 mL in water at room temperature.

43. Method of preparing a sweetened fiber,
wherein the sweetened fiber comprises a sweetener attached to at least one molecule of fiber, wherein each of the at least one molecule of fiber is attached to the sweetener through an oxygen atom of the sweetener via a glycosidic bond, and wherein the at least one molecule of fiber comprises trisubstituted saccharide monomers,
wherein the method comprises
combining the fiber and the sweetener to obtain a fiber mixture,
combining the fiber mixture with an acid to obtain a fiber paste, and
heating the fiber paste to obtain a heated fiber paste, the heated fiber paste comprising the sweetened fiber.

44. The method of claim 43, wherein the method further comprises combining the heated fiber paste with water to obtain a second fiber mixture.

45. The method of claim 44, wherein the method further comprises heating the second fiber mixture.

46. The method of any one of claims 43 to 45, wherein the fiber is obtained from dextrinization of starch.

47. The method of claim 43, wherein the method further comprises, prior to the combining of the sweetener and the fiber, dextrinizing a starch to obtain the fiber, optionally the dextrinizing of the starch comprises heating the starch in presence of a second acid.

48. The method of any one of claims 43 to 47, wherein the acid comprises a protic acid, optionally the protic acid is selected from citric acid, HCl, acetic acid, sulfuric acid, phosphoric acid, nitric acid, formic acid, tartaric acid, malic acid, lactic acid, oxalic acid, succinic acid, benzoic acid, propionic acid, butyric acid, glycolic acid, maleic acid, fumaric acid, malonic acid, acrylic acid, and combinations thereof, optionally the protic acid is citric acid, HCl, or acetic acid.

49. The method of any one of claims 43 to 47, wherein the acid comprises a Lewis acid, optionally the Lewis acid is boric acid.

50. The method of any one of claims 43 to 49, wherein the acid is in the form of an aqueous solution.

51. The method of claim 50, wherein the aqueous acid solution comprises the acid at a concentration of about 0.02% w/v to about 4% w/v, about 0.04% v/v to about 3% w/v, about 0.04% w/v to about 2% v/v, about 0.04% w/v, about 0.5% w/v, about 1% w/v or about 2% w/v.

52. The method of any one of claims 43 to 51, wherein the acid is combined with the fiber mixture in combination with water.

53. The method of any one of claims 43 to 52, wherein the acid is combined with the fiber mixture substantially in the absence of water.

54. The method of any one of claims 43 to 52, wherein the sweetener is combined with the fiber at about 0.5% w/w to about 5% w/w, about 1% w/w to about 4% w/w, about 1.5% w/w to about 3% w/w, or about 2% w/w based on the weight of the fiber, optionally the sweetener is a natural sweetener.

55. The method of any one of claims 43 to 54, wherein the sweetener is combined with the fiber at about 0.01% w/w to about 0.5% w/w, about 0.01% w/w to about 0.4% w/w, about 0.02% w/w to about 0.2% w/w, about 0.05% w/w to about 0.15% w/w, or about 0.1% w/w based on the weight of the fiber, optionally the sweetener is a synthetic sweetener.

56. The method of any one of claims 43 to 55, wherein the heating of the fiber paste is carried out at about 50° C. to about 170° C., about 50° C. to about 155° C., about 55° C. to about 65° C., about 60° C. to about 70° C., about 100° C. to about 140° C., about 130° C. to about 155° C., about 140° C. to about 155° C., or about 150° C.

57. The method of any one of claims 43 to 56, wherein the heating of the fiber paste is carried out for about 3 hours to about 12 hours, about 4 hours to about 7 hours, or about 4 hours to about 6 hours.

58. The method of any one of claims 43 to 57, wherein the method further comprises cooling the heated fiber paste prior to the combining of the heated fiber paste with the water.

59. The method of any one of claims 43 to 58, wherein the heating of the second fiber mixture is carried out at about 50° C. to about 170° C., about 50° C. to about 155° C., about 55° C. to about 65° C., about 60° C. to about 70° C., about 100° C. to about 140° C., about 130° C. to about 155° C., about 140° C. to about 155° C., or about 150° C.

60. The method of any one of claims 43 to 59, wherein the heating of the second fiber mixture is carried out for about 1 hour to about 6 hours, about 1.5 hour to about 5 hours, or about 2 hours to about 5 hours.

61. The method of any one of claims 43 to 60, wherein the method further comprises purifying the sweetened fiber, optionally by ion exchange resin.

62. A sweetened fiber prepared by a method as defined in any one of claims 43 to 61.

63. A sweetened fiber composition comprising at least one of a sweetened fiber as defined in any one of claims 1 to 42 and 62, optionally comprising bulking fiber.

64. An edible product comprising the sweetened fiber of any one of claims 1 to 42 and 62.

65. The edible product of claim 64, wherein the edible product is a food product or a beverage product.

66. The edible product of claim 65, wherein the food product is selected from baked goods, dairy product, frozen dessert, dressing, condiments, spreads, cereal, granola, confections, pasta, grain products, prepared meals, processed fruits, dried fruits, sauces, processed nut products and canned foods.

67. The edible product of claim 66, wherein the baked goods are selected from cakes, cookies, biscuits, and breads.

68. The edible product of claim 65, wherein the beverage product is selected from dairy products, liquid meal replacements, soft drinks, instant beverage products, creamers, and juices.

69. The edible product of claim 68, wherein dairy product is a fermented dairy product, optionally yogurt or kefir.

70. The edible product of claim 68, wherein the instant beverage products are selected from instant coffee products, instant tea products and mixtures thereof.

71. The edible product of any one of claims 68 to 70, wherein the instant beverage products are liquid products.

72. The edible product of any one of claims 68 to 70, wherein the instant beverage products are solid products.

73. The edible product of claim 64, wherein the edible product is a nutraceutical product.

74. The edible product of claim 73, wherein the nutraceutical product is selected from a protein mix, a vitamin supplement, a fiber supplement, nutrition bar, and meal replacement.

75. A sweetener product comprising the sweetened fiber of any one of claims 1 to 42 and 62 in a packaging.

76. The sweetener product of claim 75, wherein the packaging is selected from a packet, a bottle, a bag, a box and a tub.

77. Use of the sweetened fiber of any one of claims 1 to 42 and 62 in the preparation of an edible product.

78. Use of the sweetened fiber of any one of claims 1 to 42 and 62 for replacing sugar in the preparation of an edible product.

79. The sweetened fiber of any one of claims 1 to 42 and 62 for use in the preparation of an edible product.

80. The sweetened fiber of any one of claims 1 to 42 and 62 for use in the replacement of sugar.
